(19) United States
(12) Patent Application Publication
(10) Pub. No.: US 2009/0182732 A1
(43) Pub. Date: Jul. 16, 2009

(54) Query based operation realization interface

(76) Inventor: Jianwei Dian, Plano, TX (US)

Correspondence Address: Jianwei Dian, 3529 Stroll Road, Plano, TX, 75025, US

(21) Appl. No.: 12/319,695

(22) Filed: Jan. 10, 2009

Related U.S. Application Data
(60) Provisional application No. 61/010,750, filed on Jan. 11, 2008.

(51) Int. Cl. G06F 17/30; G06F 3/048

(52) U.S. Cl. 707/5; 707/3; 715/727; 707/E17.008; 707/E17.014; 707/E17.017

(57) ABSTRACT

Method and apparatus for an operation realization interface. In some embodiments, the method and apparatus provides a user query interface for a user to enter a query to describe her goal of a product. Then, the method and apparatus processes the query to determine appropriate operations of the product that, when realized, realize the user's goal. Finally, the method and apparatus manipulates the product to realize the appropriate operations so to realize the user's goal.

### CROSS-REFERENCE TO RELATED APPLICATIONS

This application is based on and claims the benefit of U.S. provisional patent application, application No. 61/010,750, filed Jan. 11, 2008, entitled “QUERY BASED OPERATION REALIZATION INTERFACE”, the content of which is hereby incorporated by reference in its entirety.

### FEDERALLY SPONSORED RESEARCH OR DEVELOPMENT

Not Applicable

### SEQUENCE LISTING OR PROGRAM

Not Applicable

### NOMENCLATURE

In this disclosure, with respect to nomenclature, in addition to considering the context of how the terms are used, for the avoidance of doubt, the following terms are explained:

“Product”—The “product” can be a piece of hardware, such as an airplane, an HDTV, a cell phone, a chair, etc., and the “product” can also be a piece of software, such as the Microsoft Windows operating system, the Apple Macintosh operating system, a Microsoft Office product (Word, Excel, PowerPoint, Outlook, etc.), etc.

“Operation”—The term “operation” refers to the fulfillment (or, discharge) of a function that a product provides.

For example, an HDTV can be turned on to display currently broadcasted content of a particular TV channel. The “turn on” of the HDTV is an operation of the HDTV. Also, “change of the TV channel to a particular channel” is another operation of the HDTV.

For another example, when using Microsoft Word to write an article, “check of spellings of uppercase words” is an operation of Microsoft Word. Also, “insertion of a table at the cursor” is another operation of Microsoft Word.

“She”—To simplify descriptions, “she” is used to refer to a user of a product under discussion. The term “she” should be interpreted as a person of any gender, and also should be interpreted as a non-human machine, such as a computer, if the machine is the “user”.

“Interface”—The term “interface” refers to the place and means by which independent systems interact or communicate with each other.

“Graphics based interface (or, graphics interface)”—The term “graphics based interface” refers to an interface that realizes interactions or communications through visual graphics.

For example, the interface of the software package Microsoft Word on a Windows PC is a window on the screen of the PC. There are various menus in the window. A user can use Microsoft Word through using the menus. This interface is a graphics based interface.

“Sound based interface (or, sound interface)”—The term “sound based interface” refers to an interface that realizes interactions or communications through sound.

For example, a cell phone has an interface with a microphone as an input device. A user can use the cell phone by orally entering sound input through the microphone.

“Graphics and sound based interface (or, graphics and sound interface)”—The term “graphics and sound based interface” refers to an interface that contains a graphics based interface (as a sub-interface) and a sound based interface (as a sub-interface).

For example, a cell phone as a whole is an interface for its users. The key pad and the display is a graphics based interface, and the microphone is a sound based interface.

“Operation realization interface”—The “operation realization interface” is an interface that is associated with a product. Users of the product can use the interface to realize desired operations of the product.

A product can have a lot of useful operations, but the product needs to provide one or more interfaces that a user can use to realize the useful operations. The interfaces are operation realization interfaces.

For an example, an HDTV typically provides a remote control board which has various buttons on it. A user of the HDTV can press appropriate buttons to realize desired operations of the HDTV, such as “turn on of the TV”, “change of the channel to a particular TV channel”, etc. Here, the remote control board is an operation realization interface.

For another example, the software package Microsoft Word on a Windows PC provides a graphics based interface, which is a window on the screen of the PC. The interface contains various menu items. A user of Microsoft Word can select/activate appropriate menus, sub-menus, sub-sub-menus, and so on, to realize desired operations of Microsoft Word, such as “check of spellings of uppercase words”, “insertion of a table at the cursor”, etc. Here, the Microsoft Word window on the screen of the PC is an operation realization interface.

An operation realization interface can be part of the product that provides the interface, such as in the Microsoft Word case, and it's also possible that an operation realization interface is not a part of the product, such as in the HDTV case. The remote control board may be deemed a separate product even it comes with the TV. Actually, some “universal” remote control boards (separate products) do have the ability to manipulate TVs of which they are not a part.

Whether or not the operation realization interface is part of the product that the interface is related to, we can all think that the operation realization interface manipulates the product to realize a user's desired operations of the product. When the operation realization interface is part of the product that provides the interface, it's actually the product that manipulates itself to realize a user's desired operations of the product, since the operation realization interface is part of the product. However, since the operation realization interface is what the user uses to realize the desired operations, we can still think in the way that the operation realization interface manipulates the product to realize the user's desired operations of the product. In this disclosure, when we say that an operation realization interface manipulates a product, it should be interpreted in this sense when the operation realization interface itself is part of the product.

By the way, in this disclosure, whenever an “operation realization interface” is mentioned, it's an operation realization interface that manipulates some product, whether a product is explicitly mentioned or implicitly implied.

“Menu based operation realization interface”—The term “menu based operation realization interface” refers to an operation realization interface of a product that provides various menu items. Users of the product can select/activate appropriate menus to realize desired operations of the product.

For an example, the operation realization interface (the remote control board) of an HDTV that was mentioned above is a menu based operation realization interface. The buttons on the remote control board function like menu items. Actually, the remote control board typically also provides a button named “menu”. If a user presses that button, then various menu items will be displayed on the HDTV so that the user can select/activate appropriate menus, sub-menus, sub-sub-menus, and so on, to realize desired operations of the HDTV.

For another example, the operation realization interface (the Microsoft Word window on the screen of a PC) of the software package Microsoft Word on a Windows PC that was mentioned above is a menu based operation realization interface. A user of Microsoft Word can select/activate appropriate menus, sub-menus, sub-sub-menus, and so on, to realize desired operations of Microsoft Word.

“Command based operation realization interface”—The term “command based operation realization interface” refers to an operation realization interface of a product that provides place and means for users of the product to enter various commands. The various commands represent various operations of the product. Users of the product can enter appropriate commands to realize desired operations of the product.

For an example, Microsoft Windows operating system provides a tool called “Command Prompt.” The Command Prompt is a window with a command prompt in the window. Users of Microsoft Windows can type in appropriate commands to realize desired operations of Microsoft Windows.

For another example, UNIX operating system provides a command based operation realization interface called shell prompt. A shell prompt is a window on the screen of a workstation. The window has a command prompt in it. Users of UNIX can type in appropriate commands to realize desired operations of UNIX.

“Menu or command based operation realization interfaces”—The term “menu or command based operation realization interfaces” refers to “menu based operation realization interfaces or command based operation realization interfaces”.

“Menu and command based operation realization interfaces”—The term “menu and command based operation realization interfaces” refers to “menu based operation realization interfaces and command based operation realization interfaces”.

“User interface”—The term “user interface” refers to the aggregate of places and means by which the users of a product interact/communicate with the product. Typically, the user interface provides means of input, which allow the users to manipulate the product, and means of output, which allow the product to produce the effects of the users' desired operations.

The overall user interface of a product (or, the interface of a product) can contain multiple operation realization interfaces. For an example, in the HDTV example mentioned above, the remote control board is an operation realization interface. Typically, the TV set is also an operation realization interface. There are buttons on the TV set that users can use to realize various operations of the HDTV. Using the remote control board may realize more operations than using the TV set, since the TV set may only have a few buttons that cover a few commonly used functionalities.

For another example, in the Microsoft Windows operating system example mentioned above, the Command Prompt is an operation realization interface. The overall interface of Microsoft Windows operating system on the screen of a monitor also contains various menus that users can use to realize various operations. The overall interface on the screen of the monitor itself is also an operation realization interface.

“Goal”—The term “goal” refers to a user's desired operations of a product. That is, it represents what the user wants to accomplish using the product. Sometimes, It's also termed as “user's goal of” a product.

“Query”—The term “query” refers to a request of desired operations of a product that is entered through an operation realization interface. A query is typically in the form of a natural human language that describes the user's desired operations of the product, or in other words, the user's goal of the product. For a same goal, different users may enter different queries in their own words to describe the same goal.

Also, in this disclosure, for simplicity, “realize” a query means to realize the user's goal (or, the user's desired operations) of a product that are described (or, indicated) in the query.

“Map”—The term “map” means to associate one group of elements with another group according to a particular criterion.

“Data structure”—The term “Data structure” refers a place and means for storing data. In other words, it refers to a data set that stores data in a particular way (the “structure”).

“Instructions”—The term “instructions” refers to machine recognizable and executable instructions. The “machine” sometimes is a computer.

“The query based operation realization interface”—This invention provides method and apparatus for an operation realization interface. The query based operation realization interface is the apparatus that performs the method.

### BACKGROUND OF THE INVENTION

A. Field of the Invention

The present invention generally relates to operation realization interfaces. Specifically, the present invention relates to an operation realization interface that provides a user query interface for a user to enter a query to describe her goal of a product, and after the user enters a query, processes the query to determine appropriate operations of the product that, when realized, realize the user's goal and finally, manipulates the product to realize the appropriate operations so to realize the user's goal.

B. Related Art of the Invention

Operation realization interfaces are interfaces that a product provides to its users. Users of the product can realize their desired operations of the product through using the operation realization interfaces.

Nowadays, menu and command based operation realization interfaces are the most popular operation realization interfaces.

Below are two examples in which operation realization interfaces are menu based operation realization interfaces. The first one is a software product example, and the second one is a hardware product example.

Software Product Example—As already mentioned in “NOMENCLATURE” section, the software package Microsoft Word on a Windows PC provides a menu based operation realization interface.

Example 1 (Microsoft Word): Suppose a user writes a document with most words in uppercase letters. For the spell checking functionality of Microsoft Word, the typical default setting is to not check words in uppercase letters. If the user wants Microsoft Word to also check words in uppercase letters, then the user can do the following: Select the menu item “Tools” by clicking on it. Select the menu item “Options” under “Tools”. Select the menu item “Spelling & Grammar” under “Options”. Uncheck the menu item “Ignore words in UPPERCASE” if it's checked. Finally, the user needs to click on the “Ok” button at the bottom of the “Spelling & Grammar” menu window. Then, Microsoft Word will check spellings of words in uppercase letters. This is the case for the Microsoft Word in Microsoft Office 2003.

If the user is using the Microsoft Word in Microsoft Office 2007, then the process will be different for turning on the spell checking for words in uppercase letters, since Microsoft changed the user interface of Microsoft Word going from Microsoft Office 2003 to Microsoft Office 2007. For the Microsoft Word in Microsoft Office 2007, first click on the “Office Button” which is a circle at the upper left corner. Select the menu item “Word Options” at the bottom of the “Office Button” menu window. Select menu item “Proofing” under “Word Options”. Uncheck the menu item “Ignore words in UPPERCASE” if it's checked. Finally, the user needs to click on the “Ok” button at the bottom of the “Word Options” menu window. Then, Microsoft Word will check spellings of words in uppercase letters.

Other popular software product examples in which menu based operation realization interfaces are provided are: Microsoft Windows operating system, Apple Macintosh operating system, and Microsoft Office products (Word, Excel, PowerPoint, Outlook, etc.).

Hardware Product Example—As already mentioned in “NOMENCLATURE” section, the operation realization interface for an HDTV typically is a menu based operation realization interface.

Other popular hardware product examples in which menu based operation realization interfaces are provided are: Cell phones, Apple iPods and Apple iPhones. Those hardware products typically have key pads, menu pads or/and menu buttons through which users can select various menu items to realize various operations. An Apple iPhone provides virtual menu buttons that are displayed on the screen of the iPhone.

Below are two examples in which command based operation realization interfaces are used.

Example 2 (Microsoft Windows): As already mentioned in “NOMENCLATURE” section, Microsoft Windows operating system provides a command based operation realization interface called “Command Prompt”. Command Prompt is a window on the screen of the monitor of a PC with a command prompt in the window. Suppose a user wants to know the IP address of her PC. Then, she can type in “ipconfig” at the command prompt to get the information. Here, “ipconfig” is a command.

Example 3 (UNIX): As already mentioned in “NOMENCLATURE” section, UNIX operating system provides a command based operation realization interface called shell prompt. A shell prompt is a window with a command prompt in the window. Suppose a user wants to know how many words are there in a text file. Then, she can type in “wc -w <file name>” at the command prompt to get the information. Here, “wc” is a command, “-w” is an argument which tells the command “wc” to count number of words, and “<file name>” is another argument which is the name of the text file.

Other popular examples in which command based operation realization interfaces are provided are: Linux operating system and Apple Macintosh operating system.

Some products provide both menu and command based operation realization interfaces. Popular examples are Microsoft Windows, Apple Macintosh, UNIX and Linux operating systems.

Sometimes, especially in software product cases, people can get wrong impression that the operation realization interface is the product itself. For example, when people use Microsoft Word on a Windows PC, the Microsoft Word window is all that people see. Thus, people tend to think that the Microsoft Word window is Microsoft Word itself. Actually, the window is only an interface that Microsoft Word provides to its users for users to use to realize various operations of Microsoft Word. This is typical for application software on Microsoft Windows PCs. (Here, “application software” refers to a subclass of computer software that employs the capabilities of a computer directly and thoroughly to a task that a user wishes to perform. This is contrasted with system software that are involved in integrating a computer's various capabilities, but typically does not directly apply them in the performance of tasks that benefit a user. Typical examples of application software are word processors such as Microsoft Word, spreadsheets such as Microsoft Excel, media players such as Microsoft Windows Media Player, etc.)

To summarize, menu and command based operation realization interfaces are meant for users of the product (that the interfaces are related to) to use to realize operations of the product. The operation realization interfaces manipulate the product to realize users' desired operations of the product.

It has been described and explained what menu and command based operation realization interfaces are, and how users use them. Below, some disadvantages of menu and command based operation realization interfaces are described.

(1) For realizing a particular goal using menu or command based operation realization interfaces, a user needs to have knowledge about the processes (menus, sub-menus, sub-sub-menus, and so on; commands and arguments of commands; orders of steps; etc.) for realizing the goal.

In menu based operation realization interfaces case, the user needs to know which menu to start with, then which sub-menu to choose, so on and so forth. In command based operation realization interfaces case, the user needs to know what commands to use and what arguments to give to the commands if arguments are necessary. In both of the cases, the user also needs to know the order in which to perform the steps.

If the user doesn't have the knowledge of the particular and exact processes for realizing the goal, then, the user needs to spend time to acquire the knowledge (such as reading user's manuals for the product) before she can realize her goal. Sometimes, the learning process can take considerable amount of time.

For menu based operation realization interfaces, a user without the knowledge for realizing her goal may take time to guess and explore menus, sub-menus, and so on, to try to see whether or not she can realize her goal. However, the exploration may take considerable amount of time ending up with no luck, since the appropriate menu (or, menus) may be buried deep in the menu hierarchy. Then, the user still has to resort to some type of learning process to acquire the necessary knowledge before the user can realize her goal.

For command based operation realization interfaces, the situation is even worse: If a user doesn't know what commands to use, then, most of the time, it's nearly impossible for the user to guess the commands. The user has to spend time to acquire the necessary knowledge before she can realize her goal using the command based operation realization interfaces.

Sometimes, even an ordinary (or, non-expert) user spends time trying to acquire the knowledge for realizing a goal, the user may still end up without all the necessary knowledge due to some reasons, such as that the help materials are too vague, too technical or too complicated for an ordinary user to understand.

(2) For realizing a particular goal using menu or command based operation realization interfaces, even for a user who has learned how to realize the goal at one time. Later on, when she needs to realize the same goal again, she may already forget the particular and exact process (menus, or, commands, etc.) Then, she needs to repeat the learning process, and the learning process will consume time again.

(3) For realizing a particular goal using menu or command based operation realization interfaces, even a user has adequate knowledge to realize her goal, the user still needs to perform the process step by step (menu by menu, or, command by command) to actually realize the goal. Sometimes, there may be a lot of steps to go through, and it may take the user considerable efforts and time to go through all the steps.

(4) Menu and command based operation realization interfaces lack flexibility in that, for realizing a same goal, users have to go through the same process (same menus, or, same commands.)

(5) A product, especially a complex software product, may have a lot of functionalities. Some of the functionalities may be very complicated. When the product uses menu or command based operation realization interfaces, it's very hard and time consuming for an ordinary user to learn the menus or commands for using all the functionalities, most of the functionalities, or even a significant fraction of the functionalities. Thus, a lot of functionalities of a product, especially a complex software product, may be unknown and thus meaningless to ordinary users, since ordinary users lack the necessary knowledge of the particular and exact processes (menus, commands, orders of steps, etc.) for using the functionalities. An example of this situation is Microsoft Windows operating system.

Example 4 (Microsoft Windows): After being used for sometime, due to various causes, a Windows PC normally will start and/or run slower and slower. An ordinary user of a PC would notice that the PC starts and/or runs slower over time, but she doesn't know how to fix the problem.

Microsoft Windows provides the functionality that can improve performance of PCs, or in other words, make PCs run faster. The functionality is achieved by using various tools of Windows. Below are some of the tools:

Remove Auto-Start Programs

Some programs set auto-start as a default choice when people install them on a PC unless people deselect the choice. A program being “auto-start” means that the program starts whenever the PC is started (or, booted), and the program is then running on the background. Normally, many people don't notice the auto-start choice (may appear in different wording) or don't know what the auto-start choice means. Thus, those programs will be installed as auto-start programs. This makes a PC start slower and run slower.

Microsoft Windows provides a tool that a user can use to remove unwanted programs from auto-start programs list on her PC. This will speed up startup of the PC and also will make the PC run faster.

Clear Out Forgotten Programs

It's quite usual that a user install new programs on her PC. After some time, she may not need some of the programs any more. However, if the programs are not removed from the PC, they will consume resources and hurt performance of the PC.

Microsoft Windows provides a tool that a user can use to remove unwanted programs from her PC. This will make the PC run faster.

Free Up Wasted Disk Space

Sometimes, unnecessary stuff can be stored on a user's PC and occupy a lot of disk space on the PC, such as a lot of temporary files that are stored on a user's PC when the user browses the web or uses some programs. Unnecessary files make a PC run slower.

Microsoft Windows provides a tool that a user can use to find and free up the wasted disk space on her PC. This will make the PC run faster.

De-Fragment a PC

When an article in a newspaper starts on the front page but continue somewhere in the middle of the newspaper, we can call the article a fragmented article. It takes more time to read an article when it's fragmented than when it is printed on consecutive pages.

Similarly, a file on a PC can be stored in fragmented sections of hard disk on the PC, or it can be stored in consecutive sections of the hard disk. It takes more time for programs to access a file when it's fragmented than when it is stored in consecutive sections of the hard disk.

On a PC, over time, more and more files are stored in fragmented sections of the hard disk. This will make the PC run slower.

Microsoft Windows provides a tool that a user can use to de-fragment her PC, meaning store a single file in consecutive sections of the hard disk on the PC. This will make the PC run faster.

Detect and Repair Disk Errors

As a user uses her PC, bad sectors on the hard disk could develop. The bad sectors on the hard disk slow down hard disk performance and sometimes make data writing (such as file saving) difficult, slow, or even impossible. This will make the PC run slower.

Microsoft Windows provides a tool that a user can use to check, detect and repair disk errors on her PC. This will make the PC run faster.

The above are some of the tools that can be used to achieve the functionality of improving performance of a PC. However, knowing existence of all the above Microsoft Windows tools is already rare in ordinary PC users, let alone knowing all menus or commands for using all the tools.

An ordinary Windows PC user typically notices that her PC starts/runs slower and slower over time, but she typically doesn't know how to check and fix the problem. She doesn't know the above tools of Microsoft Windows that can improve the performance of her PC. Even though the Windows' functionality of improving the performance of a PC is useful, it's so complicated that it's unknown and thus meaningless to ordinary users.

(6) For products that use menu based or/and command based operation realization interfaces, especially for software products, when a user of one product switches to use another product, even though the two products have the same or similar functionalities, the user may still need to take considerable time to learn specific menus or commands of the new product, since the old product and the new product may have different menus or commands for a same functionality.

Example 5 (UNIX to Windows): UNIX and Windows are two operating systems, and they have a lot of same functionalities. However, when a software developer on a UNIX machine switches to use a Windows machine, she needs to take a lot of time to learn how to realize operations on a Windows machine even though she already knew how to realize the same operations on a UNIX machine, since the two operating systems have different menus and commands for a lot of same functionalities. For instance, on a UNIX machine, the command to list all contents under a directory is “Is”. However, on a Windows machine, the command to list all contents under a directory is “dir”.

For menu and command based operation realization interfaces, the issue of spending time to learn again to use same or similar functionalities not only exists for different products, it also exists for a same product if the product changes names of the menus or the layout of the menus in a menu based operation realization interface case, or if the product changes the commands in a command based operation realization interface case. For example, in “Example 1 (Microsoft Word)” that was mentioned above, for turning on spell checking for words in uppercase letters, the processes are different for the Microsoft Word in Microsoft Office 2003 and the Microsoft Word in Microsoft Office 2007, since Microsoft changed the names of a lot menus and also changed the layout of the menus in the Microsoft Word user interface going from the 2003 version to the 2007 version. Thus, even for a user who has already learned how to turn on spell checking for words in uppercase letters using the Microsoft Word 2003 version, she would have to spend time again to learn how to do it in the Microsoft Word 2007 version.

The above is a list of some of the disadvantages of menu and command based operation realization interfaces. Even though the list is not exhaustive, it clearly showed some obvious and significant drawbacks of menu and command based operation realization interfaces.

Operation realization interfaces are widely used in various products. Having seen the above disadvantages of menu and command based operation realization interfaces, it will be very useful if a new type of operation realization interfaces can be invented to avoid the above disadvantages of menu and command based operation realization interfaces.

C. Objects and Advantages of the Invention

The present invention provides method and apparatus for an operation realization interface which is termed as “query based operation realization interface”. The query based operation realization interface overcomes the disadvantages (that were described in “B. Related Art of the Invention”) of menu and command based operation realization interfaces.

The query based operation realization interface of the present invention provides a user query interface. A user can enter a query in her own words using the user query interface to indicate her goal (that is, her desired operations) of the product that the query based operation realization interface manipulates. The query based operation realization interface takes the responsibilities to process the query to determine appropriate operations of the product that, when realized, realize the user's goal and to manipulate the product to realize the appropriate operations so to realize the user's goal.

Here, the plural form “operations” is used to represent the operations of the product that, when realized, realize the user's goal. The reason is that usually even a very simple user query contains multiple operations of the product. For example, in the example user query “make my PC run as fast as possible” that is mentioned above, it may seem to the user it's only one operation, but it actually involves performing multiple operations, such as removing unnecessary auto-start programs, de-fragmenting the PC, detecting and repairing disk errors, etc., and some of these operations may be further decomposed into smaller operations. Of course, it can happen that a user query contains only a single basic operation that can't be decomposed into smaller operations, but that case is less often. Thus, for the simplicity of descriptions, in all the cases, the plural form “operations” is used to represent the operations of the product that, when realized, realize the user's goal. However, it should be aware that the “operations” can contain only a single operation in rare cases. In what follows, in the context of operations of the product that, when realized, realize the user's goal, the term “operations” should be construed in that way: It usually contains multiple operations, but it can contain only a single operation.

Here, the term “user query interface” refers to an interface through which a user of a product can enter a query to indicate her goal of the product. In what follows, unless otherwise stated, “user query interface” always refers to the user query interface provided by the query based operation realization interface of the present invention.

The user query interface of the query based operation realization interface can be a graphics based interface, a sound based interface, a graphics and sound based interface, or the alike.

When using the query based operation realization interface of the present invention, a user can enter through the user query interface what operations of the product (her goal) she wants to realize. What the user enters through the user query interface is the user's query. The query is in the form of natural human language, not in the form of any specific commands. Different users can enter different queries in their own words for a same goal. A same user can enter different queries for a same goal at different times.

After receiving a query from the user, the query based operation realization interface takes the responsibilities to process the query to determine appropriate operations of the product that, when realized, realize the user's goal and to manipulate the product to realize the appropriate operations so to realize the user's goal. The user doesn't need to know how her goal is realized.

“Example 1 (Microsoft Word)” was used as an example to show how a menu based operation realization interface works. The same example will be used to show how the query based operation realization interface works.

For a query based operation realization interface for Microsoft Word, the user query interface may be a graphics based interface, such as the one shown in FIG. 2. The user query interface contains an input box in which a user can type in her query. When the user wants Microsoft Word to do spell checking for not only normal words but also words in uppercase letters, she can simply type in input box a query like “check spellings of all words”. The query based operation realization will process the query to determine appropriate operations of Microsoft Word that, when realized, realize the user's goal and to manipulate Microsoft Word to realize the appropriate operations so to realize the user's goal: Setting up Microsoft Word so that it checks spellings of all words.

For the same goal of “check spellings of all words”, the same user can enter the query “check spellings of all words” at one time, and enter another query like “check spellings of words in lowercase letters and words in uppercase letters” at another time. Also, different users can enter different queries in their own words for the same goal of “check spellings of all words”. For example, one user can enter a query like “check spellings of all words”. A second user can enter a query like “check spellings of words in lowercase letters and words in uppercase letters”. A third user can enter a query like “do spell checking for all words”. The query based operation realization interface takes the responsibility to process (or, analyze) the user's query to determine the user's goal. In this example, it will be determined that the goals of all the queries are the same: Check spelling of all words.

Comparing with the disadvantages of menu and command based operation realization interfaces described in “B. Related Art of the Invention”, the query based operation realization interface of the present invention has the following advantages.

(1) As mentioned in “B. Related Art of the Invention”, for realizing a particular goal using menu or command based operation realization interfaces, a user needs to have knowledge about the processes (menus, sub-menus, sub-sub-menus, and so on; commands and arguments of commands; orders of steps; etc.) for realizing the goal. If the user doesn't have the necessary knowledge, then, she needs to spend time to acquire the knowledge.

In contrast, for realizing a particular goal using the query based operation realization interface, a user only needs to enter her goal as a query in the user query interface, and then the user sees her goal realized. The user doesn't need to know how her goal is realized. Thus, even if the user doesn't have necessary knowledge of the particular and exact process (menus, commands, orders of steps, etc.) that is otherwise necessary for using menu or command based operation realization interfaces to realize her goal, she still can realize her goal without spending anytime to learn the knowledge. This obviously provides great convenience to users and saves users' time.

In “Example 1 (Microsoft Word)” mentioned in “B. Related Art of the Invention”, when using the currently available menu based operation realization interface, a user needs to know what menu, sub-menu, sub-sub-menu, etc. to choose to make Microsoft Word check spellings of words in uppercase letters.

In contrast, when using the query based operation realization interface, a user doesn't need to know the menus. She only needs to type in a query like “check spellings of all words” in the user query interface of the query based operation realization interface to make Microsoft Word check spellings of uppercase words.

(2) As mentioned in “B. Related Art of the Invention”, for realizing a particular goal using menu or command based operation realization interfaces, even for a user who has learned the process of realizing the goal at one time, later on, when she needs to realize the same goal again, she may already forget the particular and exact process (menus, or, commands.) Then, she needs to take time to repeat the learning process for acquiring the necessary knowledge for realizing the goal.

In contrast, for realizing a particular goal using the query based operation realization interface, a user doesn't need to remember any specific ways of expressing a goal as a query. She can enter one query at one time, and at a later time, she can enter a different query for the same goal. The query based operation realization interface takes the responsibilities to process the user's query to determine the user's goal and manipulate the product to realize the user's goal.

Again, “Example 1 (Microsoft Word)” mentioned in “B. Related Art of the Invention” will be used as an example to explain the situation. When using the query based operation realization interface, a user can enter a query like “check spellings of all words” at one time. Then, to realize the same goal at a later time, she can enter “check spellings of words in lowercase letters and words in uppercase letters”, or something similar. Again, the query based operation realization interface takes the responsibility to analyze the user's query to determine the user's goal. In this example, it will be determined that the goals of all the queries are the same: Check spelling of all words.

(3) As mentioned in “B. Related Art of the Invention”, for realizing a particular goal using menu or command based operation realization interfaces, even a user has adequate knowledge to realize her goal, the user still needs to perform the process step by step (menu by menu, or, command by command) to actually realize the goal. Sometimes, there may be a lot of steps to go through, and it may take the user considerable time and efforts to go through all the steps.

In contrast, for realizing a particular goal using the query based operation realization interface, a user only needs to enter her goal as a query in the user query interface, and then the user sees her goal realized. This saves the user's time.

(4) As mentioned in “B. Related Art of the Invention”, menu and command based operation realization interfaces lack flexibility in that, for realizing a particular goal, users have to go through the same process (same menus, or, same commands.)

In contrast, in using the query based operation realization interface, for a same goal, different users are free to enter different queries using their own words. The query based operation realization interface takes the responsibilities to process the user's query to determine the user's goal and manipulate the product to realize the user's goal.

Again, “Example 1 (Microsoft Word)” mentioned in “B. Related Art of the Invention” will be used as an example to explain the situation. When using the query based operation realization interface, one user can enter a query like “check spellings of all words”. A second user can enter a query like “check spellings of words in lowercase letters and words in uppercase letters”. A third user can enter a query like “do spell checking for all words”. In this example, it will be determined by the query based operation realization interface that the goals of all the queries are the same: Check spelling of all words.

(5) As mentioned in “B. Related Art of the Invention”, a product, especially a complex software product, may have a lot of functionalities. Some of the functionalities may be very complicated. When the products use menu or command based operation realization interfaces, it's very hard and time consuming for an ordinary user to learn the menus or commands for using all the functionalities, most of the functionalities, or even a significant fraction of the functionalities. Thus, a lot of functionalities of a product, especially a complex software product, are unknown and thus meaningless to ordinary users, since ordinary users don't have the necessary knowledge of the particular and exact processes (menus, commands, orders of steps, etc.) for using the functionalities.

In contrast, when a product uses the query based operation realization interface of the present invention, complicated functionalities of the product are as easy as simple functionalities to any users. Whether a piece of functionality is complicated or not, what a user needs to do is the same: Enter her goal as a query. The user doesn't need to know how trivial or how complicated her task is to the product, or how her goal is realized. The query based operation realization interface handles everything that is necessary to realize the user's goal, whether trivial or complicated.

If it happens that the user enters a goal that is beyond the capabilities of the product that the query based operation realization interface manipulates, the query based operation realization interface will feedback to the user to let her know what she requests is beyond what the product can do.

In “Example 4 (Microsoft Windows)” that was mentioned in “B. Related Art of the Invention”, when using the query based operation realization interface, a user doesn't need to know all the tools that she can use to improve the performance of her Windows PC. When a user notices that her PC starts/runs significantly slower, she can simply enter a query like “make my PC run as fast as possible”. Then, the query based operation realization interface will do all the things that can improve the performance of the user's Windows PC, such as checking and prompting the user to remove unnecessary auto-start programs, de-fragmenting the PC, detecting and repairing disk errors, etc. With the query based operation realization interface, an ordinary user can use complicated functionalities of Windows that are otherwise unknown and meaningless to ordinary users.

(6) As mentioned in “B. Related Art of the Invention”, for products that use menu based or/and command based operation realization interfaces, especially for software products, when a user of one product switches to use another product, even though the two products have the same or similar functionalities, the user still may need to take considerable time to learn the specific menus or commands of the new product, since the old product and the new product may have different menus or commands for same operations.

In contrast, for products that use the query based operation realization interface, when a user of one product switches to use another product with the same or similar functionalities, the user doesn't need to take time to learn how to use the new product, since the queries that the user needs to enter are the same for same operations, whether on the old product or on the new product.

In “Example 5 (UNIX to Windows)” that was mentioned in “B. Related Art of the Invention”, when using the query based operation realization interface with both UNIX and Windows operating systems, whether on UNIX or on Windows, the user can enter the same query “list all contents under the directory” to see contents under the directory.

Other objects and advantages of the present invention are:

(7) Another advantage of the query based operation realization interface is that, whenever necessary, the query based operation realization interface combines multiple functionalities of a product to realize a user's goal. This actually extends the functionalities of the product.

In “Example 4 (Microsoft Windows)” that was mentioned in “B. Related Art of the Invention”, a user needs to sue various tools in Microsoft Windows to optimize performance of her Windows PC. Windows doesn't have a single menu or command that she can utilize to achieve her goal.

However, with the query based operation realization interface, the user can simply enter a query like “make my PC run as fast as possible”. Then, the query based operation realization interface will perform the various operations to optimize the performance of the user's PC.

Further objects and advantages of the present invention will become apparent from a consideration of the drawings and ensuing descriptions.

Because of its many significant advantages described above, the query based operation realization interface of the present invention is obviously superior to the currently popular menu and command based operation realization interfaces.

### SUMMARY

Method and apparatus for an operation realization interface. In some embodiments, the method and apparatus provides a user query interface for a user to enter a query to describe her goal of a product. Then, the method and apparatus processes the query to determine appropriate operations of the product that, when realized, realize the user's goal. Finally, the method and apparatus manipulates the product to realize the appropriate operations so to realize the user's goal.

### DRAWINGS

FIG. 1 shows a general block diagram which illustrates the method for the query based operation realization interface.

FIG. 2 shows one form of the layout of a graphics based user query interface.

FIG. 3 shows the relationship between the query based operation realization interface and the product in the preferred embodiment.

FIG. 4 shows the flowchart of the preferred embodiment.

FIG. 5 shows the flowchart of the first additional embodiment.

FIG. 6 shows the flowchart of the second additional embodiment.

FIG. 7 shows the flowchart of the third additional embodiment.

FIG. 8 shows the relationship between the query based operation realization interface and the product in the fifth additional embodiment

FIG. 9 shows the flowchart of the manual analysis of unrealizable historical queries.

FIG. 10 shows the flowchart of the update of Historical Query Store.

FIG. 11 shows a graphics based user query interface for a plurality of products.

### DETAILED DESCRIPTION

In what follows, unless specified otherwise, the terms “the product” and “the products” always refer to the product and the products, respectively, that the query based operation realization interface manipulates.

As mentioned in the “NOMENCLATURE”, this invention provides method and apparatus for an operation realization interface. The query based operation realization interface is the apparatus that performs the method. Thus, all the descriptions below, except “B-5-1) Manual analysis of unrealizable historical queries”, apply to both the method and apparatus for the operation realization interface, regardless of whether the details of the invention are described in the context of the method or in the context of the query based operation realization interface. (The “Manual analysis of unrealizable historical queries” is performed by the vender of the query based operation realization interface. See “B-5-1) Manual analysis of unrealizable historical queries” for details.)

Details of the present invention will be described with nine sections: A. General Description; B. Preferred Embodiment; C. First Additional Embodiment; D. Second Additional Embodiment; E. Third Additional Embodiment; F. Fourth Additional Embodiment; G. Fifth Additional Embodiment; H. More Variations; and I. Conclusions, Ramifications and Scope of the Present Invention.

### A. General Description

The general description will be described with two parts: A-1: General Description of the Method; and A-2: Query Based Operation Realization Interface for a Plurality of Products.

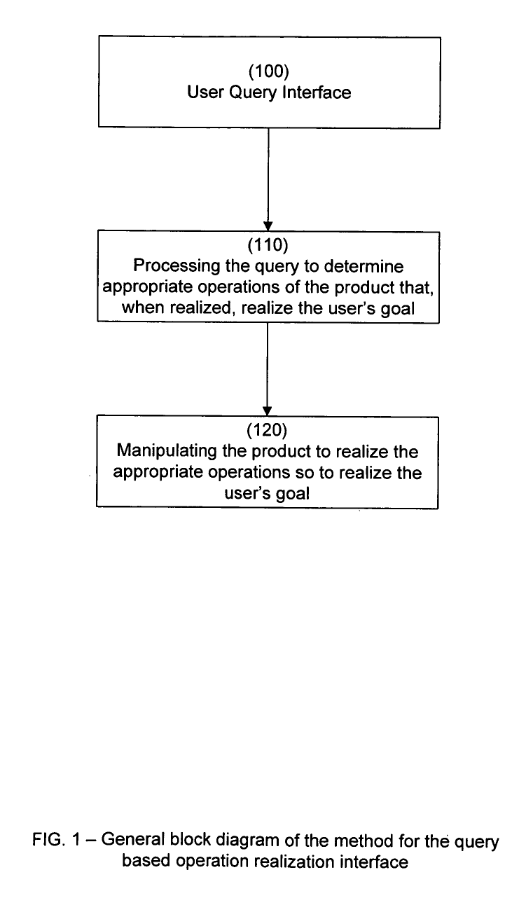

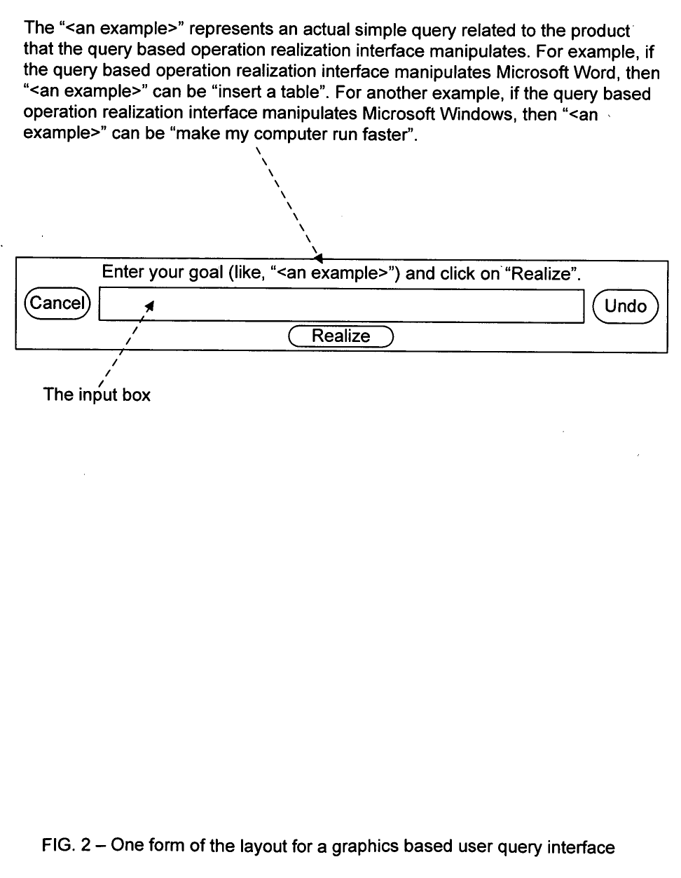

### A-1: General Description of the Method (FIG. 1 and FIG. 2)

FIG. 1 is a block diagram illustrating a flowchart of the method for the query based operation realization interface in the most general form.

The query based operation realization interface provides a user query interface (100). The user query interface is the user interface of the query based operation realization interface. A user of the query based operation realization interface can use the user query interface to enter a query to describe her desired operations of the product that the query based operation realization interface manipulates. After a user enters a query, the query based operation realization interface will process the query to determine appropriate operations of the product that, when realized, realize the user's goal and manipulate the product to realize the appropriate operations so to realize the user's goal.

A user query interface can be a graphics based interface, a sound based interface, a graphics and sound based interface, or another appropriate form. For example, FIG. 2 shows one form of the layout of a graphics based user query interface. A user can enter her query in the input box and click on the “Realize” button (or, simply press the “enter” key on a keyboard). Then, the query based operation realization interface processes the query and realizes the user's goal.

After a user entered a query using the user query interface, the query based operation realization interface will process the query to determine appropriate operations of the product that, when realized, realize the user's goal. This is represented by (110) in FIG. 1.

For a particular goal, the query based operation realization interface doesn't require a user to enter a query in a particular way. The user can simply use her own words to describe her goal (namely, her desired operations of the product). The user doesn't need to know how to realize her goal, such as particular menus, commands, etc. that are otherwise necessary for using menu or command based operation realization interfaces. For a same goal Different users can enter different queries in their own words. Also, for a same goal, a user can enter one query at one time and enter a different query at a different time. The query based operation realization interface takes the responsibility to process the query to determine appropriate operations of the product that, when realized, realize the user's goal.

After the query based operation realization interface determined the appropriate operations of the product that, it will manipulate the product to realize the appropriate operations so to realize the user's goal. This is represented by (120) in FIG. 1.

Depending on how the query based operation realization interface is implemented with respect to the product, the query based operation realization interface will trigger appropriate mechanisms to manipulate the product to realize the appropriate operations. For example, if the query based operation realization interface is implemented as part of the product, then, the query based operation realization interface can use the internal mechanisms of the product to realize the appropriate operations. For another example, if the query based operation realization interface is not implemented as part of the product, then, the query based operation realization interface needs some interaction mechanisms between itself and the product so that it can use to manipulate the product to realize the appropriate operations.

The user query interface (100) may be the only thing that is accessible (or, viewable, if the user query interface is a graphics based interface) to users, and the processing of the query (110) and the manipulating of the product (120) are internal to the query based operation realization interface. Whenever the query based operation realization interface is activated, the user query interface is available to users for them to use. When using the query based operation realization interface, what a user does is enters a query through the user query interface and then sees her goal realized by the query through the user query interface. Sometimes, the user may need to provide additional information to the query based operation realization interface, such as values of some variables involved in realizing her goal, if the user doesn't already provide such information in the query. In this case, the query based operation realization interface will prompt the user to enter the additional information.

The query based operation realization interface can be implemented as part of the product that it manipulates, and it can also be implemented as a separate product. Regardless of whether or not the query based operation realization interface is implemented as part of the product, and regardless of whether the product is a hardware product, software product, or something else, the query based operation realization interface can be implemented as a piece of software. In other words, the blocks (100), (110) and (120) in FIG. 1 represent sets of machine recognizable and executable instructions that are implemented through some programming languages, such as Java, C, C++, Fortran, Shell scripts or other types of programming languages. The query based operation realization interface (namely, all the instructions) can be stored on a digital storage medium, such as a hard disk, a removable CD, DVD or USB flash drive, or other types of digital storage media. When the query based operation realization interface is activated (namely, when the instructions are executed), the instructions of (100) will provide the user query interface that a user can use. After a user enters a query through the user query interface, the instructions of (110) will process the query to determine appropriate operations of the product that, when realized, realize the user's goal, and the instructions of (120) will manipulate the product to realize the appropriate operations so to realize the user's goal.

The above is the general description of the method for query based operation realization interface. Greater details will be further described below in the preferred embodiment, additional embodiments and various variations.

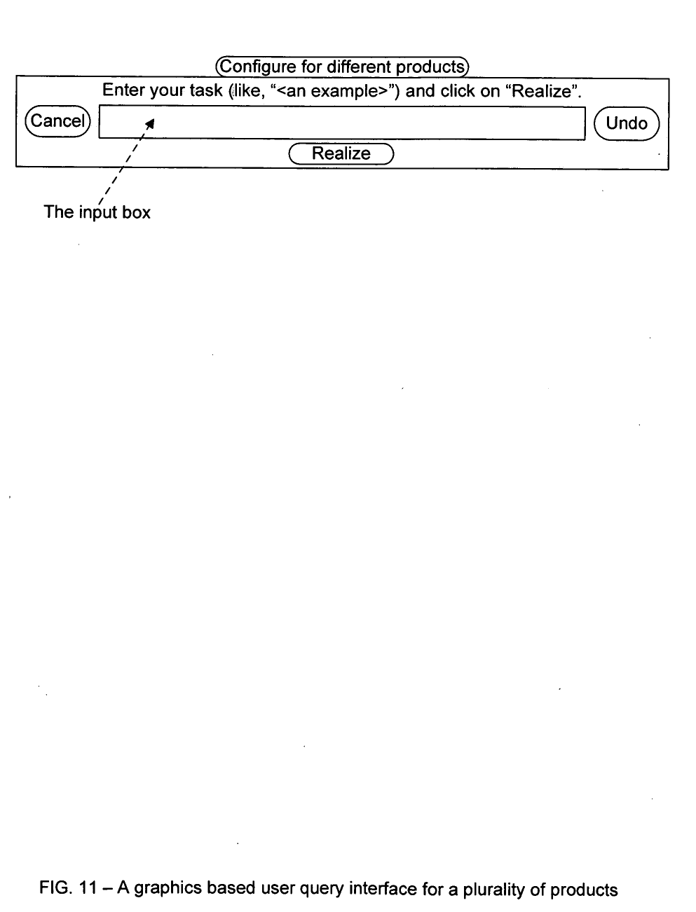

### A-2: Query Based Operation Realization Interface for a Plurality of Products (FIG. 1, FIG. 2 and FIG. 11)

A query based operation realization interface can be implemented to manipulate one product or one type of products, just like the remote control board of a particular brand of TV is designed and manufactured to manipulate that particular brand of TV. However, just like a TV remote control board can be designed and manufactured to manipulate multiple brands of TVs (the so called universal TV remote control board), a query based operation realization interface can also be implemented to manipulate a plurality of products or a plurality of types of products.

For example, the query based operation realization interface can provide a configuration feature so that a user can configure it in a particular way to manipulate a particular product or a particular type of products. FIG. 11 shows an example of the possible form of the user query interface of such a query based operation realization interface. In the example in FIG. 11, a user can click on the button “Configure for different products” to configure the query based operation realization interface to manipulate a particular product.

This type of query based operation realization interface will be more appropriate for manipulating a plurality of products that have similar functionalities, such as the Windows, UNIX, Linux, etc. operating systems. The reason is that for products that have similar functionalities, the “processing the query to determine appropriate operations of the product that, when realized, realize the user's goal” in FIG. 1 may be implemented mostly the same, since the products have similar functionalities, namely similar operations. The major differences may mostly reside in the “manipulating the product to realize the appropriate operations so to realize the user's goal” in FIG. 1, since different products may have different mechanisms to realize a same operation.

Also, instead of providing a configuration feature in the user query interface, there are other ways to implement the mechanism for setting up the query based operation realization interface for a particular product. For example, one way is let the query based operation realization interface configure itself when it's installed on a product.

Taking the example of Windows, UNIX, Linux, etc. operating systems mentioned above, the query based operation realization interface can be implemented in the following way: When a user installs the query based operation realization interface, the query based operation realization interface will detect what the operating system is and then configure itself in the particular way for manipulating that particular operating system. In this way, there is no need for a configure feature in the user query interface, and the user query interface can stay the same as the one shown in FIG. 2, which is simpler.

As mentioned above, a query based operation realization interface that manipulates a plurality of products is more appropriate if the products have similar functionalities. However, it also should be pointed out that, if an implementer desires, the implementer can implement a query based operation realization interface to manipulate a plurality of products that have significantly different functionalities. Of course, in such a case, it may be more complicated to implement the query based operation realization interface.

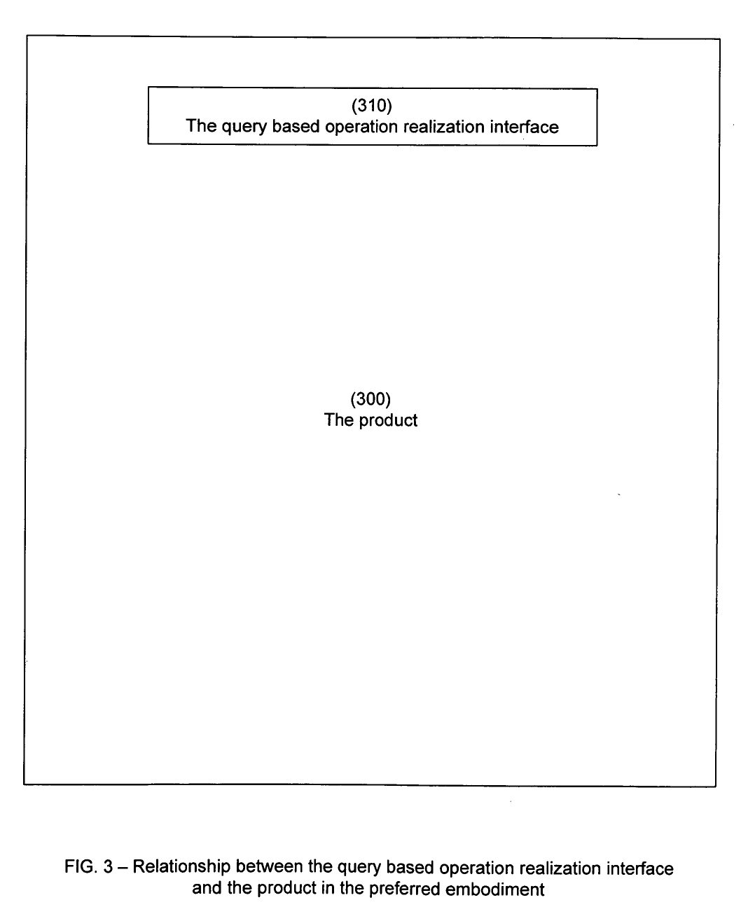

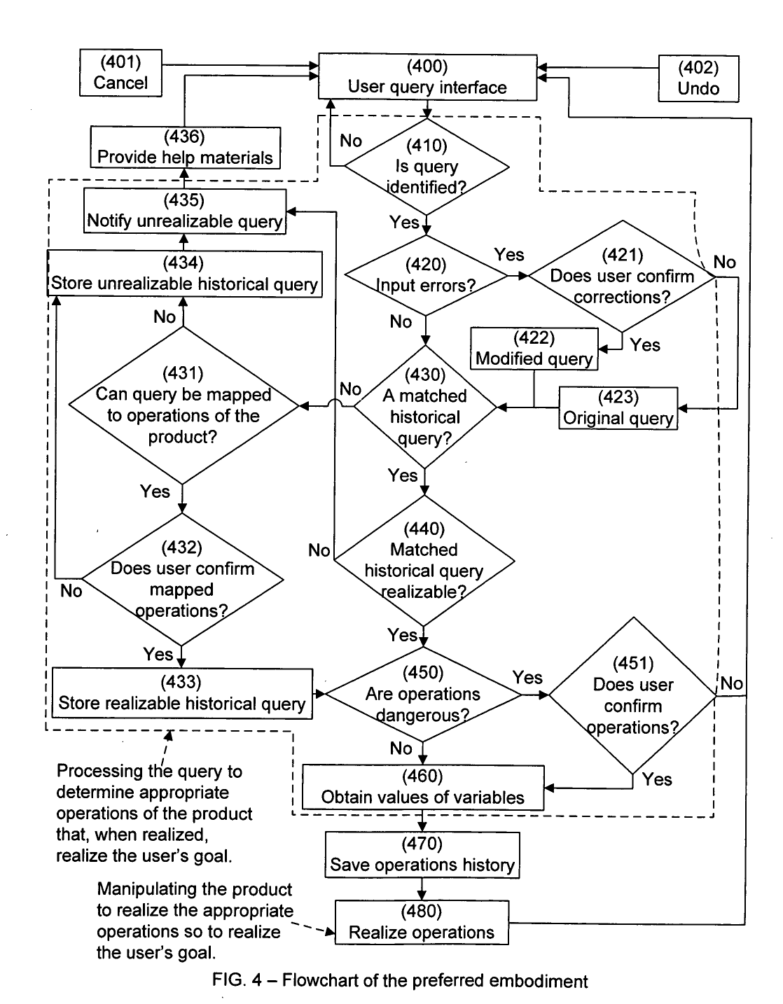

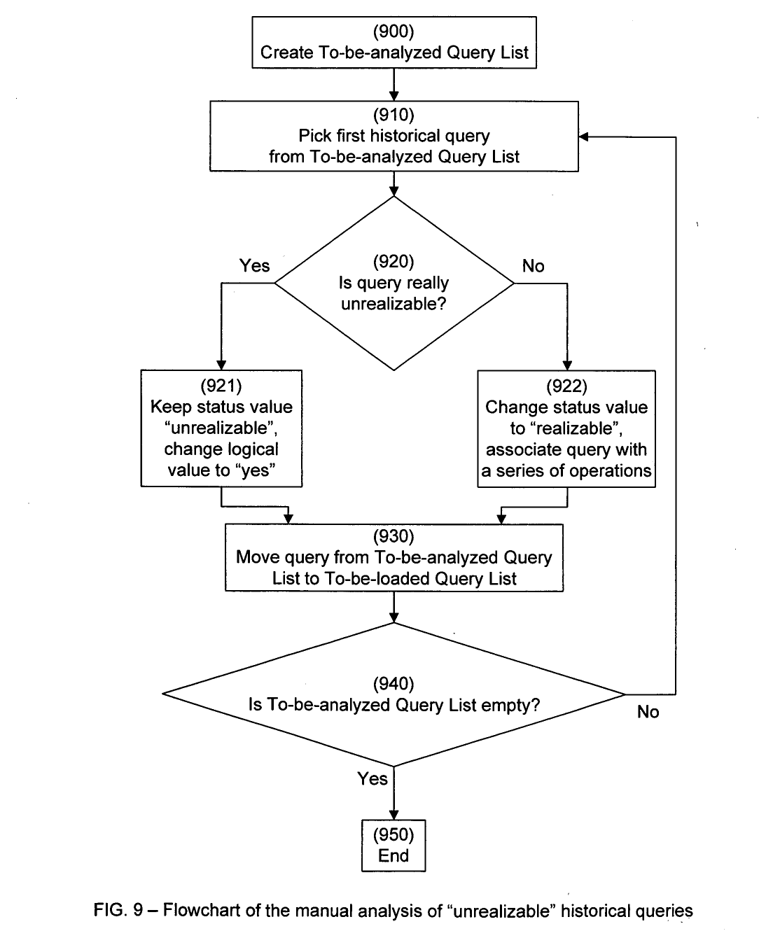

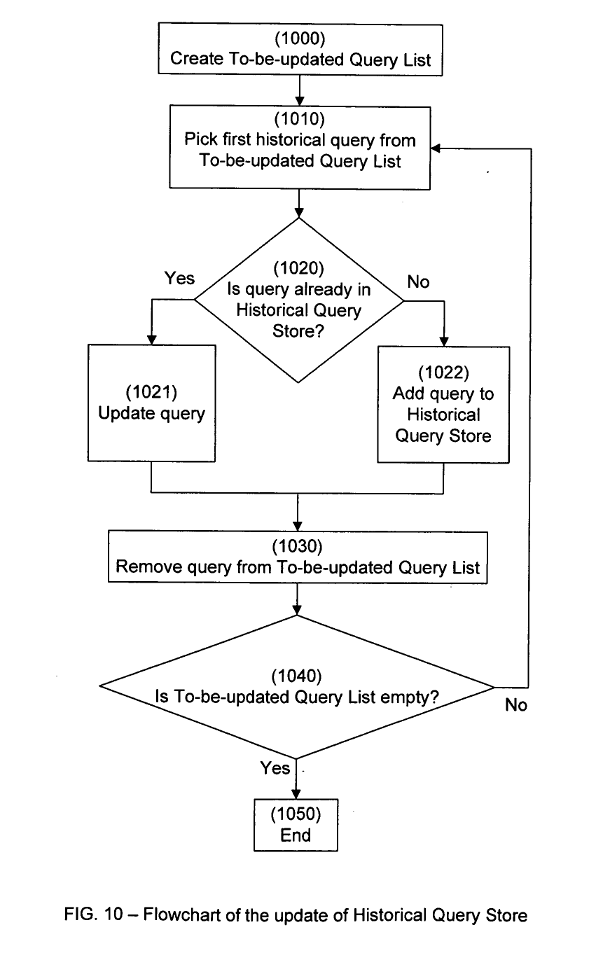

### B. Preferred Embodiment (FIG. 2, FIG. 3, FIG. 4, FIG. 9 and FIG. 10)

Details of the preferred embodiment will be described with six parts: B-1: Relationship between the query based operation realization interface and the product; B-2: User input device; B-3: The query based operation realization interface feedback device; B-4: Detailed flow of instructions of the query based operation realization interface; B-5: How to perform periodic update of the Historical Query Store; and B-6: How to use the query based operation realization interface.

### B-1: Relationship Between the Query Based Operation Realization Interface and the Product (FIG. 3)

As said above, the query based operation realization interface can be implemented as part of the product that the query based operation realization interface manipulates, and the query based operation realization interface can also be implemented as an independent product.

It's preferred to implement the query based operation realization interface as part of the product that the query based operation realization interface manipulates. FIG. 3 shows this preferred form of relationship between the query based operation realization interface (310) of present invention and the product (300) that the query based operation realization interface manipulates. The query based operation realization interface (310) uses the internal mechanisms of the product (300) to manipulate the product to realize operations.

In this preferred embodiment, it's assumed that the query based operation realization interface is implemented as part of the product that the query based operation realization interface manipulates.

As already mentioned above, the query based operation realization interface can be implemented in the form of a piece of software. If the query based operation realization interface (310) manipulates a software product (300), the query based operation realization interface (310) can be implemented as part of the software product (300). In this case, the instructions of the query based operation realization interface (310) may be stored on the digital storage medium on which the instructions of the software product itself are stored.

If the query based operation realization interface (310) manipulates a hardware product (300), the query based operation realization interface (310) can be implemented as part of the software on the hardware product (300) if the hardware product (300) already contains software. The query based operation realization interface (310) can also be implemented as an independent piece of software on the hardware product (300) regardless of whether or not the hardware product (300) already contains software. In any case, the query based operation realization interface (310), namely, the instructions of (310), can be stored on a digital storage medium that is part of the hardware product or that is associated with the hardware product.

The query based operation realization interface can be added as an additional part (or, functionality, feature, etc.) of the product, embedded in the overall user interface of the product. The product may already have associated existing operation realization interfaces, whether menu based, command based, or in other forms. Those existing operation realization interfaces can be kept unchanged. A user of the product can still use the existing operation realization interfaces if using the existing operation realization interfaces is simpler in some cases, and the user knows the exact processes (menus, commands, orders of steps, etc.) of realizing her goals in those cases.

For example, Microsoft Windows operating system already has both menu and command based operation realization interfaces. Then, the query based operation realization interface can be a new operation realization interface that is added to Microsoft Windows. Users of Microsoft Windows can use the query based operation realization interface, and the users can also use the existing menu and command based operation realization interfaces if using them is simpler in some cases.

For another example, an Apple's iPhone already has a menu based operation realization interface, with menus displayed on the display screen of the iPhone. Then, the query based operation realization interface can be a new operation realization interface that is added to the iPhone. Users of the iPhone can use the query based operation realization interface, and the users can also use the existing menu based operation realization interface if using it is simpler in some cases.

The query based operation realization interface is available for a user to use whenever the product is available for the user to use. Using Microsoft Word on a Windows PC as a software product example, when a user runs Microsoft Word to get the Microsoft Word window on the screen of the monitor of the PC, the user query interface of the query based operation realization interface is available to the user for her to use. The user query interface may contain an input box, such as the one shown in FIG. 2. The user can type a query into the input box.

Using a cell phone as a hardware product example, whenever the cell phone is turned on and in operational mode, the user query interface of the query based operation realization interface is available on the screen of the cell phone for the user to enter queries.

Another option for the availability of the query based operation realization interface is to add a new menu item if existing operation realization interfaces are menu based, or add a new command if existing operation realization interfaces are command based, so that a user can use the new menu item or the new command to turn on or turn off the query based operation realization interface as desired.

### B-2: User Input Device

The query based operation realization interface of the present invention always has a user query interface through which users can enter queries. Thus, there must be a user input device so that a user can use to enter her queries.

The user input device can be a hand based device, sound based device, hand and sound based device, or the alike. Keyboards, keypads, electrical handwriting boards and similar devices are examples of hand based user input devices. Microphones and similar devices are examples of sound based user input devices. Telephones and similar devices are examples of hand and sound based user input devices.

Whenever feasible, hand based input devices, such as a keyboard, are the preferred type of user input devices. The reason is that, inputs from hand based input devices, such as a keyboard, are relatively more accurate and easier to identify than inputs from sound based devices, such as a microphone. (For the same reason, the user query interface of the query based operation realization interface is preferred to be a graphics based interface. This will be described in greater details in “B-4: Detailed flow of instructions of the query based operation realization interface”.)

If the user input device is sound based, such as a microphone, then additional confirmations may be needed to identify user inputs. The reason is that sound inputs typically are realized through human oral languages. Due to the nature of human oral languages, such as different pronunciations and different accents for a same word, sound inputs usually are less accurate and more difficult to identify. Thus, for sound based inputs, extra work may need to be done to identify the inputs. For example, an automatic telephone answering system often reads back a user's input to confirm that it identifies the user's input correctly.

As mentioned above, hand based input devices, such as a keyboard, are generally the preferred user input devices due to their input accuracy. It also should be noted that some hand based input devices, such as electrical handwriting boards, are not as good as other hand based input devices, such as keyboards, with respect to accuracy and ease to identify inputs. However, electrical handwriting boards and similar devices may be preferable in some cases due to their convenience for users to use.

Even though hand based input devices are generally preferred, under some circumstances, using a sound based input device may be more appropriate for the query based operation realization interface.

For an example, using sound based input devices on a cell phone, such as an Apple's iPhone, may be more appropriate than using hand based input devices on the cell phone. The reason is that, on most simple cell phones, one key button corresponds to multiple alphabetic letters which makes it time consuming to type in a query. On more complicated cell phones, a single key button corresponds to a single alphabetic letter, but the key buttons are too small which makes it time consuming to type in a query. On an Apple iPhone, the displayed alphabetic letters on the screen are too small which also makes it time consuming to type in a query. Thus, using sound based input devices on a cell phone may be more appropriate.

For another example, using a sound based input device may be appropriate for a person who is driving a car. The reason is that, when a person is driving a car, her hands are typically occupied. However, she can still talk to a sound based input device to enter her query for the query based operation realization interface. Of course, for a user who is handicapped and for whom it's difficult to use hands, a sound based input device may also be appropriate. (Details of the embodiment of using a sound based input device will be described in “C. First Additional Embodiment”.)

If the product that the query based operation realization interface manipulates already has associated and appropriate user input devices, then the query based operation realization interface can be so implemented that a user can use the existing input devices to enter her queries. For example, there is normally a keyboard already associated with a PC. Thus, a query based operation realization interface on a PC can be implemented in a way that a user can use the keyboard to enter queries in the user query interface.

If the product doesn't have associated user input devices, or the existing user input devices are not appropriate, then appropriate input devices may need to be added for the query based operation realization interface to use.

Keyboard is a good user input device. In some cases, even though the product doesn't have an associated classic keyboard, the product has some type of “semi-keyboard” or “virtual-keyboard” that can be used to enter alphabetic letters. For example, even though one key button has multiple associated letters, a simple cell phone does have key buttons that can be used to enter alphabetic letters. This is an example of “semi-keyboard”.

For another example, the remote control board of a Dishnetwork satellite TV receiver has the functionality to display all the alphabetic letters on the TV screen with a cursor. A user can use the remote control board to move the cursor to a desired letter to enter that particular letter. This is an example of “virtual-keyboard”. An Apple's iPhone also has the functionality of providing a “virtual-keyboard” on its display screen. A user can use fingers to touch the letters on the display screen to enter the letters.

Even in cases that the product already has associated user input devices, if desirable, additional user input devices can be added in order for the query based operation realization interface to use. For example, if the product only has hand based user input devices, but a sound based user input device is desirable, then a sound based user input device can be added for the query based operation realization interface to use; if the product only has sound based user input devices, but a hand based user input device is desirable, then a hand based user input device can be added for the query based operation realization interface to use.

In this preferred embodiment of the current invention, it's assumed that the user input device is a hand based device. An additional embodiment will be described in section “C. First Additional Embodiment” in which the user input device is a sound based device.

Even though a user input device is necessary for users to use the query based operation realization interface, it should be pointed out that it may be that the user input device is not part of the query based operation realization interface. As already mentioned, the query based operation realization interface is typically implemented as a piece of software. It's common that the user input device is not part of a software product. This can be explained using Microsoft Word as an example.

Microsoft Word needs a user input device for a user to use it. For example, when writing an article using Microsoft Word on a PC, a user typically uses the keyboard to enter texts. The keyboard is a user input device that Microsoft Word (or, a user of Microsoft Word) uses. However, the keyboard is not part of Microsoft Word. Similarly, the user input device that is necessary for the query based operation realization interface (or in other words, necessary for users to use the query based operation realization interface) may not be part of the query based operation realization interface.

In some cases, the query based operation realization interface is desirable to be implemented as part of a product to manipulate the product, but the product doesn't have a user input device or the product doesn't have an appropriate user input device for users (of the query based operation realization interface) to use, then an appropriate user input device needs to be added to the product for the query based operation realization interface to use. However, in reality, those cases may be less common.

In some cases, the query based operation realization interface is implemented as a separate product to manipulate a product, then an appropriate user input device needs to be on the separate product (on which the query based operation realization interface is implemented) for the query based operation realization interface to use.

### B-3: The Query Based Operation Realization Interface Feedback Device

After a user enters a query through the user query interface, the query based operation realization interface takes the responsibilities to process the query to determine appropriate operations of the product that, when realized, realize the user's goal and manipulate the product to realize the appropriate operations so to realize the user's goal. Sometimes, in the process of realizing the user's goal, the query based operation realization interface may need additional inputs from the user. For example, for the query based operation realization interface for Microsoft Word, if the user enters a query like “create a table”, then the query based operation realization interface will ask the user to enter the number of rows and the number of columns that she desires for the table. In this case, the query based operation realization interface needs a feedback device (or, output device) to interact with the user.

Sometimes, when the query based operation realization interface can't determine the appropriate operations, the query based operation realization interface will provide to the user with feedback, and the query based operation realization interface may also provide to the user with help materials based on the user's query. In this case, the query based operation realization interface also needs a feedback device to provide any feedback or help materials to the user.

Sometimes, the appropriate operations will generate outputs, and the outputs need to be returned to the user. In this case, the query based operation realization interface also needs a feedback device to provide the outputs to the user.

A feedback device is a graphics based or sound based device. Also, feedback devices may already exist with the product which the query based operation realization interface is implemented to manipulate. The query based operation realization interface can simply use the existing feedback devices.

For example, if the software product that the query based operation realization interface manipulates is a piece of software on a PC, the query based operation realization interface can use screen of the PC monitor to interact with a user. The query based operation realization interface can display messages on the monitor to ask a user to enter additional input, and the query based operation realization interface can also use the monitor to provide feedback or help materials to the user. If the PC has a speaker, the query based operation realization interface can also use the speaker as a feedback device. In this example, the screen of the PC monitor is a graphics based device, and the speaker of the PC is a sound based device.

When both graphics and sound based feedback devices are available, it's preferable to use graphics based feedback devices. The reason is that sound based outputs may immediately disappear after being played, whereas graphics outputs are much more durable, typically implemented in the way that they stay there until the user provides the requested input or until the user choose to make the graphics outputs disappear.

Even though graphics based feedback devices are generally preferred, under some circumstances, using a sound based feedback device may be more appropriate.

For example, for the query based operation realization interface that manipulates a product meant to be used by a person who is driving a car, using a sound based feedback device may be more appropriate, since reading graphics outputs at somewhere in the car may distract the driver's attention and cause accidents, especially when it takes significant time to read the graphics outputs. In this case, it may be more appropriate to use a sound based feedback device, like a speaker, to interact with the user or provide feedback to the user.

As mentioned above, feedback devices may already exist with the product that the query based operation realization interface manipulates. If one or more of the feedback devices are appropriate, the query based operation realization interface can simply use one or more of those feedback devices. In cases that existing feedback devices are not appropriate, or no feedback devices exist with the product, then an appropriate feedback device needs to be added for the query based operation realization interface to use to interact with users.

It should be pointed out that, similar to the situation of the user input device, it may be that the feedback device is not part of the query based operation realization interface. As already mentioned, the query based operation realization interface is typically implemented as a piece of software. It's common that the feedback device is not part of a software product. This can be explained using Microsoft Word as an example.

Microsoft Word on a PC uses the screen of the monitor as a feedback device to display the texts that a user enters, to prompt the user to make selection in multiple choices, etc. However, the screen of the monitor is not part of Microsoft Word.

Also similar to the situation of the user input device is that, when the product doesn't have a feedback device, the current feedback devices of the product are not appropriate, or when the query based operation realization interface is implemented as a separate product, then an appropriate feedback device needs to be added if a feedback device is desired.

### B-4: Detailed Flow of Instructions of the Query Based Operation Realization Interface (FIG. 2 and FIG. 4)

The block diagram FIG. 4 shows the flowchart of the preferred embodiment. In FIG. 4, each block (either a rectangle or a diamond) represents a set of machine recognizable and executable instructions. The instructions are implemented through some programming languages, such as Java, C, C++, Fortran, Shell scripts or other types of programming languages. Once executed, the instructions of each block will perform the functions of that block (namely, will perform what that block does).

Below are the correspondences between the three blocks in FIG. 1 that were described in “A. General Description of the Method” and the blocks in FIG. 4 that will be described below: the “User query interface” described in “A. General Description of the Method” comprises block (400); the “Processing the query to determine appropriate operations of the product that, when realized, realize the user's goal” described in “A. General Description of the Method” comprises blocks (410), (420), (421), (422), (423), (430), (431), (432), (433), (434), (435), (440), (450), (451) and (460); and the “Manipulating the product to realize the appropriate operations so to realize the user's goal” described in “A. General Description of the Method” comprises the block (480). There are also extra blocks (401), (402), (436) and (470) in FIG. 4. Below are detailed descriptions of all the blocks in FIG. 4.

The query based operation realization interface provides a user query interface (400). The user query interface is the user interface of the query based operation realization interface. In other words, a user of the query based operation realization interface can use the user query interface to interact with the query based operation realization interface. A user of the query based operation realization interface can use the user query interface to enter a query to describe her goal of the product.

It's preferred that the user query interface (400) be implemented as a graphics based interface, and the graphics based interface contains an input box that a user can use to enter a query. It's also preferred that a text be placed above the box to explain how to enter a query and/or give a very simple sample query. FIG. 2 shows one form of the layout of a preferred graphics based user query interface. (Variations of the layout in FIG. 2 may be implemented, such as changing the shapes of the parts, placing the text and/or buttons at different locations, etc.)

In FIG. 2, in the sentence “Enter your goal (like, “<an example>”) and click on “Realize”.” that is above the input box, “<an example>” represents an actual simple sample query related to the product that the query based operation realization interface manipulates. The actual content of the simple sample query depends on what the product is. For example, if the product is Microsoft Word, then “<an example>” can be “insert a table”. For another example, if the product is Microsoft Windows, then “<an example>” can be “make my computer run faster”.

After a user enters her query through the user query interface (400), she can let the query based operation realization interface start to realize her goal. Taking the user query interface in FIG. 2 as an example, after the user enters a query, she can click on the “Realize” button to let the query based operation realization interface start the realization of her goal. She can also simply press the “enter” key on a keyboard to let the query based operation realization interface start the realization of her goal, if the keyboard is the input device and if the query based operation realization interface is implemented in the way that the “enter” key also serves a trigger for the start of the realization of the query.

After the user enters a query and lets the query based operation realization interface start to realize the query, the query based operation realization interface proceeds to (410) to start processing the query to determine appropriate operations of the product that, when realized, realize the user's goal.

For typical hand based input devices, such as keyboards and keypads, the inputs are accurate and immediately identified when they are being entered. However, for some types of hand based input devices, such as a handwriting board, extra efforts may be needed to identify the user's inputs. Such extra efforts may include presenting the identified query to the user for her to confirm.

If the query based operation realization interface is not able to identify the user's inputs at (410), then the query based operation realization interface notifies the user and returns to the user query interface (400) for the user to enter another query.

If the query based operation realization interface successfully identifies the user's inputs at (410), then the query based operation realization interface proceeds to (420) to check whether or not there are likely input errors in the user's query, such as typos.

If the query based operation realization interface determines that there are no input errors in the user's query, then the query based operation realization interface proceeds to (430) to perform utilizing historical queries to determine the appropriate operations.

If the query based operation realization interface determines that there are likely input errors in the user's query, then the query based operation realization interface proceeds to (421) to try to correct the input errors. At (421), the query based operation realization interface makes corrections to the original query and presents the corrections to the user for her confirmation.

For example, in using Microsoft Word, if a user enters a query “create a rable with 6 rows and 8 columns”, then, most probably, the user wants a “table” with 6 rows and 8 columns. The word “rable” is a typo of “table”. In this case, the query based operation realization interface determines that there is an input error, and it also presents the corrected query “create a table with 6 rows and 8 columns” to the user for the user to confirm.

When interacting with the user at (421), as mentioned in “B-3: The query based operation realization interface feedback device”, it's preferable to use graphics feedback devices, such as the screen of a PC monitor. However, when only sound based feedback devices are available or using a sound based feedback device is more appropriate, such as for the query based operation realization interface that manipulates a product meant to be used by a person who is driving a car, then the query based operation realization interface can use the sound based feedback devices to interact with the user.

If the user confirms the corrections, then the query based operation realization interface takes modified query at (422) and proceeds to (430); if the user denies the corrections, then the query based operation realization interface takes the original query at (423) and proceeds to (430).

At this point, the query based operation realization interface has proceeded to (430) through some path. At (430), the query based operation realization interface will try to utilize historical queries to determine the appropriate operations. One way to do that is to check whether or not there is a matched historical query.

In this disclosure, at any given time point, a “historical query” refers to a query that was entered into the user query interface by a user before that time point, and that the query based operation realization interface completed handling of the query before that time point.

In this disclosure, “handling” a query includes “processing the query to determine appropriate operations of the product that, when realized, realize the user's goal” and “manipulating the product to realize the appropriate operations so to realize the user's goal”. The starting point of the “handling” is after the user enters a query and lets the query based operation realization interface begin to handle the query. There are two possible ending points of the “handling”: 1) if the query based operation realization interface successfully determines the appropriate operations, then it will realize the user's goal and return to the user query interface for the user to enter a new query; and 2) if the query based operation realization interface can't determine the appropriate operations due to any reasons, then it will end the handling of the query and return to the user query interface for the user to enter a new query. In the second case, nothing is realized, and the query based operation realization interface may notify the user of that. Thus, that the query based operation realization interface completed handling of a query is different from that the query based operation realization interface successfully realized the query. It can happen that the query based operation realization interface completed handling of a query without realizing the query.

The query based operation realization interface provides a first data structure (or, data set) that stores all historical queries. The query based operation realization interface provides a status parameter for each historical query in the first data structure to indicate whether or not the historical query is realizable. In this disclosure, a query is “realizable” means that the query can be realized by the query based operation realization interface; otherwise, the query is “unrealizable”.

For a historical query in the first data structure, if the query based operation realization interface successfully realized the query before, then the query based operation realization interface assigns a status value of “realizable” to the status parameter of the realizable historical query, and the query based operation realization interface associates with the realizable historical query a series of operations of the product that were performed to realize the query. Note that it's “a series of” operations. This means that the order of the operations maters. In order to realize the realizable historical query, the operations must be performed in the order that they were performed when realizing the realizable historical query before. Otherwise, if the order is changed, even all the operations are performed, the realizable historical query may not be realized again. Thus, the order in which the operations were performed should be preserved in the first data structure.

For a historical query in the first data structure, if the query based operation realization interface didn't successfully realize the query before, then the query based operation realization interface assigns a status value of “unrealizable” to the status parameter of the unrealizable historical query.

The query based operation realization interface provides a logical parameter for each unrealizable historical query to indicate whether or not the unrealizable historical query had been manually analyzed by humans.

If an unrealizable historical query hadn't been analyzed by humans, then the query based operation realization interface assigns a logical value of “no” to the logical parameter of the unrealizable historical query; and if an unrealizable historical query had been analyzed by humans, then the query based operation realization interface assigns a logical value of “yes” to the logical parameter of the unrealizable historical query.

The above first data structure that stores all the historical queries is called a Historical Query Store. The status value, logical value, series of operations if applicable, etc. that are associated with a historical query in the Historical Query Store are called the “attributes” of that historical query. At what stages that the values of the various parameters are assigned values and what values to assign will, be described below when various blocks are described in details.

The logical parameter of an unrealizable query in the Historical Query Store represents whether or not that particular unrealizable query has been manually analyzed by humans. This parameter is for the sake of making periodic update of the Historical Query Store, and the periodic update will be described in detail in “B-5: How to perform periodic update of the Historical Query Store”.

A means for forming the historical queries to be stored in Historical Query Store is: When the actually entered query doesn't contain any variables, then take the exact query as the historical query, and when the actually entered query contains variables, then do not take the values of the variables, but use special symbols, such as using “$” to represent a variable.

For example, for a query based operation realization interface for Microsoft Windows on a PC, “make my PC run as fast as possible” may be an actual query that a user entered. When storing the query in the Historical Query Store, the query based operation realization interface simply stores the exact query “make my PC run as fast as possible”, since the query contains no variables. For another example, for a query based operation realization interface for Microsoft Excel, “add from row 3 to 88 and column 9 to 100” may be an actual query that a user entered. When storing the query in the Historical Query Store, the query based operation realization interface doesn't store the values of “3”, “88”, “9” or “100”, but stores the query as “add from row $ to $ and column $ to $”, where each “$” represents a variable that should have a numerical value.

(Of course, another way to store a query in the Historical Query Store is to simply store the exact query, whatever it is. However, this is not the preferred way to store historical queries.)

At (430), the query based operation realization interface checks into the Historical Query Store to see whether or not there is a matched historical query. If there is a matched historical query and the matched historical query is realizable, then the query based operation realization interface will be able to determine the appropriate operations for realizing the user's goal, since each realizable historical query is associated with a series of operations that can be performed to realize the historical query.

Here, a “matched historical query” is a historical query that is the same as the query being handled, taking into consideration of variables, if any, in the historical query. For example, for a query based operation realization interface for Microsoft Excel, if the query being handled is “add from row 8 to 200 and column 10 to 80”, and there is a historical query “add from row $ to $ and column $ to $”, then the historical query is a matched historical query of the query being handled. However, a historical query “sum up row $ to $ and column $ to $” is not a matched historical query of the query being handled. In summary, besides variables, all other texts should be the same as those in the user query to make a historical query a matched historical query.

If there is a matched historical query, then the query based operation realization interface proceeds to (440) to check into the Historical Query Store to see whether or not the matched historical query is realizable.

Actually, if a matched historical query is in the Historical Query Store, then the query based operation realization interface immediately knows whether or not the matched historical query is realizable, since in the Historical Query Store each query has a status parameter of either the status value “realizable” or “unrealizable”.

If the matched historical query is realizable, which means that a series of operations are associated with the realizable matched historical query in the Historical Query Store, then the query based operation realization interface identifies the appropriate operations of the product as the series of operations associated with the realizable matched historical query in the Historical Query Store. Then, the query based operation realization interface proceeds to (450) to do dangerous operations check.

At (440), if the query based operation realization interface finds out that the matched historical query is unrealizable, which means that the appropriate operations can not be determined, then the query based operation realization interface performs ending handling of the query. That is to proceed to (435) to notify the user that the query based operation realization interface was not able to realize her query. In another respect, this means that the “processing the query to determine appropriate operations of the product that, when realized, realize the user's goal” is not successful. Then, the query based operation realization interface proceeds to (436) to provide help materials that are relevant to the query.

Most products have manuals that users can read to learn how to realize a particular goal. Besides possible hard copies, a software product typically also provides soft copies of such help materials with the software. Whenever a user uses the software, the help materials are available for the user to use. The help feature may provide a search functionality with a search query box in which a user can enter a query to search for help materials that are relevant to the search query.

For example, if a user opens Microsoft Word window to write an article, there is a small button at the upper right corner which is a circle with a question mark “?” in the circle. Clicking on the small button will bring up help materials that the user can use. There is also a box in which a user can enter a search query to get relevant help materials. (This example is based on the Microsoft Word in Microsoft Office 2007. For the Microsoft Word in Microsoft Office 2003, there is a “Help” menu on the menu bar, and the sub-menu “Microsoft Office Word Help” provides the help materials.)

The query based operation realization interface of the present invention utilizes the search functionality of the help feature in order to provide a user with help materials that the product would provide with the user's query (that is, the query being handled by query based operation realization interface) as a search query. In more detailed descriptions, the query based operation realization interface will 1) take the user's query as a search query, 2) search the help materials database of the product with the search query, by using the search functionality of the product, and 3) provide the user with matched documents generated by the searching.

In case the help feature of the product doesn't provide the search functionality, or the product doesn't provide the help feature at all, then implementers of the query based operation realization interface may add such a search functionality to the query based operation realization interface for the query based operation realization interface to use to search and provide help materials to the user. Of course, if desired, the implementers of the query based operation realization interface may also choose not to add the search functionality, and simply not provide any help materials under this situation.

Also, it should be noted that it may happen that the query based operation realization interface provides nothing at (436) in case that the query based operation realization interface gets nothing from the help feature of the product, with the user's query as a search query.

For providing notification to the user at (435) and help materials to the user at (436), it's generally preferable to use graphics feedback devices, such as the screen of a PC monitor. A graphics based device is preferable especially for providing help materials to the user at (436), since help materials may have a lot of content. It will be difficult or even impossible to remember or digest the help materials through a sound based device like a speaker, since sound outputs may disappear immediately after being played.

As mentioned in “B-3: The query based operation realization interface feedback device”, even though graphics based feedback devices are generally preferred, under some circumstances, using a sound based feedback device may be more appropriate, such as for the query based operation realization interface that manipulates a product meant to be used by a person who is driving a car.

If the feedback device is a sound based device, then, providing notification at (435) may be still feasible, but it may be impractical to provide help materials at (436). In this case, the query based operation realization interface may simply not provide help materials at (436).

After provides help materials (if any) at (436), the query based operation realization interface returns to (400) for the user to enter a new query. See above for descriptions of (400).

At (430), if the query based operation realization interface finds out that there are no matched historical queries in the Historical Query Store, then the query based operation realization interface deals with the case that there are no matched historical queries. In this preferred embodiment, the dealing with the case that there are no matched historical queries is to proceed to (431) to try to perform mapping the query to operations of the product to determine the appropriate operations for realizing the user's goal, with the “operations of the product” termed as mapped operations.

Before describing a method for mapping the user's query to operations of the product, the concept of a type of internal predefined queries, standardized queries, will be introduced.

To represent a particular functionality of the product, the query based operation realization interface uses an internal predefined query. Such a predefined query is called a standardized query. Different functionalities of the product are represented by different standardized queries. The standardized queries altogether cover all the functionalities of the product.

A standardized query is a query between a single operation of the product and actual queries that a user may enter through the user query interface in that a standardized query may contain more than just a single operation of the product, but a standardized query won't contain a lot of operations as possibly contained in an actual query a user may enter.

A standardized query can contain variables that represent values required by some of the operations that need to be performed to realize the standardized query. For example, “add from row $ to $ and column $ to $” can be a standardized query for Microsoft Excel. Here, “add” is an operation, and each “$” represents a variable which needs a numerical value. In other words, the means for forming the standardized queries is similar to the means for forming the historical queries in Historical Query Store: not specifying values of variables, but using special symbols to represent variables.

The user's manual of the product is a good source for establishing the standardized queries. (Sometimes, the user's manual is in the form of online help materials along with the product. That is especially the case when the product is a software product.) The reason is that the user's manual typically covers all the functionalities, namely all the operations, of the product. Thus, the standardized queries can be created by using the user's manual as a reference. Thus, the means for forming the standardized queries can also include using the user's manual as a reference to create the standardized queries.

The query based operation realization interface provides a second data structure to store all the standardized queries. In the second data structure, each standardized query is associated with a series of operations of the product that can be performed to realize that particular standardized query. This second data structure is called a Standardized Query Store.

The Standardized Query Store is predefined and is internal to the query based operation realization interface. It's just a method that the query based operation realization interface uses internally to represent all the functionalities of the product. A user of the query based operation realization interface doesn't need to know anything about the Standardized Query Store.

As already mentioned, a standardized query in the Standardized Query Store may contain more than one operation. There may be overlap of operations among standardized queries in the Standardized Query Store. Of course, the standardized queries may also be implemented in a way that each standardized query only contains one operation, two different standardized queries contain two different operations, and all the standardized queries altogether cover all the operations, and thus all the functionalities, of the product. In this case, there is no overlap of operations for the standardized queries in the Standardized Query Store.

After introducing the Standardized Query Store, a method through which the query based operation realization interface can map the user's query to operations of the product can be described: The query based operation realization interface will try to map the user's query to one or more standardized queries.

The criterion for mapping the user's query to one or more standardized queries is that the goals of the one or more standardized queries combined is the same as the goal of the user's query. Therefore, if the query based operation realization interface can map the user's query to one or more standardized queries, then the user's query can be mapped to operations of the product, since each standardized query is associated with a series of operations of the product

One method that can be used to do the mapping is key word analysis that will be described below.

When using a product, comparing to the possible words and the ways to combine the words that a person may use to express her ideas, thoughts, etc., in daily life, the possible words and the ways to combine the words that a user may use in a query to express what she wants to accomplish with the product is very limited.

Due to the very limited possibilities of words/ways that a user may use to express her goal of the product, normally, by key word analysis, the query based operation realization interface will be able to map the user's query to one or more standardized queries, and thus map the user's query to a series of operations of the product.

Taking Microsoft Excel as an example, suppose that “add from row $ to $ and column $ to $” is a standardized query, where the four $'s represent four variables. Then, “sum up row 3 to 100 and column 3 to 9”, “sum from row 6 to 68 and column 1 to 3”, “add up from row 1 to 1000 and column 1 to 10”, and similar queries can all be mapped to the standardized query “add from row $ to $ and column $ to $” with the specified values of the variables, since “sum”, “sum up”, “add up” are all key words that represent the same operation that “add” represents.

For another example, for Microsoft Windows, “remove unnecessary programs from startup” can be a standardized query. When the query based operation realization interface receives a query like “delete unnecessary programs in the start”, “delete unnecessary stuff in the start”, “remove bad stuff in the boot”, “remove bad programs from startup menu”, “clean up the startup menu”, or similar queries, the query based operation realization interface will map the query to the internal standardized query “remove unnecessary programs from startup”. Then, the query based operation realization interface will map the user's query to the operations that are associated with the standardized query “remove unnecessary programs from startup”.

As mentioned above, the Standardized Query Store is internal to the query based operation realization interface. It's a method through which the query based operation realization interface maps the user's query to corresponding operations of the product. A user of the query based operation realization interface doesn't need to have any knowledge of the Standardized Query Store. The user can express her goal using her own words. The query based operation realization interface takes the responsibility to do the key word analysis to map the user's query.

Of course, more complicated methods other than key word analysis can be utilized to map the user's query to one or more standardized queries, and different methods, other than the standardized query mapping, can be utilized to map the user's query to operations of the product. However, more complicated methods can be more difficult to implement.

It's obvious that, with the mapping functionality of the query based operation realization interface, a user doesn't need to know how to realize her goal, such as particular menus, commands, etc. that are otherwise required by menu or command based operation realization interfaces.

It's obvious that, with the mapping functionality of the query based operation realization interface, a user doesn't need to remember any particular ways to represent her goals. Even for a same goal, she can enter one query at one time and enter a different query at a different time.

Due to possible mistakes that the query based operation realization interface may make when it maps the user's query to one or more standardized queries, the query based operation realization interface provides a safeguard mechanism (or, safeguard means) later on at (432) to ask the user to confirm that the mapped operations are the user's desired operations.

At (431), if mapping the query to operations of the product is successful, which means that the query based operation realization interface does map the user's query to one or more standardized queries and which means that the mapped operations are determined, then the query based operation realization interface deals with the case that the mapping the query to operations of the product is successful. The dealing with the case that the mapping the query to operations of the product is successful is to proceed to the safeguard mechanism (432) to ask the user to confirm whether or not the one or more standardized queries represent what she wants to realize (or in other words, the user's desired operations).

When asking the user to confirm the mapped operations, or in other words, the one or more mapped standardized queries, if needed, the query based operation realization interface can provide explanations of the relationship between the one or more mapped standardized queries and the user's original query. For example, if the user's query is the example user query “make my PC run as fast as possible” that is mentioned before, the mapped operations may include removing unnecessary auto-start programs, de-fragmenting the PC, detecting and repairing disk errors, etc. The query based operation realization interface can provide explanations of these operations and of why they help improve the performance the PC, since the user may not have such knowledge.

When interacting with the user at (432), as mentioned in “B-3: The query based operation realization interface feedback device”, it's preferable to use graphics feedback devices, such as the screen of a PC monitor. However, when only sound based feedback devices are available or using a sound based feedback device is more appropriate, the query based operation realization interface will use the sound based feedback devices to interact with the user at (432).

At (432), if the user confirms that the one or more mapped standardized queries combined is what she desires, which means that the appropriate operations are determined, then the query based operation realization interface performs dealing with the case that the user confirms the mapped operations. It's proceeding to (433) to store the user's query in the Historical Query Store, assign a status value of “realizable” to the status parameter of the query and associate with the realizable query a series of operations of the product, with the series of operations being the operations that are associated with the one or series of confirmed standardized queries. Here, the query based operation realization interface also identifies the appropriate operations of the product as the series of operations that had been associated with the query. Then the query based operation realization interface proceeds to (450) to check whether or not there are dangerous operations involved in realizing the user's query.

When store the user's query in the Historical Query Store at (433), if the user's query contains values of variables, then the query based operation realization interface doesn't store the values of the variables, but instead store each variable as a symbol, such as $. Here and in what follows, “values” of variables are not necessarily numerical values. They can be in other forms, such as alphabetical letters.

The way in which that the query based operation realization interface determines whether or not there are variables in the user's query is whether or not there are variables in the mapped standardized queries.

For example, Microsoft Excel example query “sum up row 3 to 100 and column 3 to 9” was mentioned above. When store this historical query, the actually stored query is “sum up row $ to $ and column $ to $”.

When the query based operation realization interface checks whether or not there is a matched historical query at (430), it considers the special symbols “$” that represent variables in a historical query as matches to the values of the variables in a user's query. For example, assume “sum up row $ to $ and column $ to $” is in the Historical Query Store, if a user enters a query like “sum up row 200 to 1000 and column 6 to 68”, then the query based operation realization interface will determine that the historical query “sum up row $ to $ and column $ to $” is a matched historical query of the user's query “sum up row 200 to 1000 and column 6 to 68”.

At (432), if the user denies the one or more mapped standardized queries, then, it means that mapping the query to operations of the product is not successful. This also implies that processing the query to determine appropriate operations is not successful. Then the query based operation realization interface performs dealing with the case that the user denies the mapped operations, which means that the appropriate operations can not be determined. The block (432) ends handling of the query by proceeding to (434) to store the user's query in the Historical Query Store as an unrealizable historical query.

The query based operation realization interface's actions at (434) are: store the user's query in the Historical Query Store, assign a status value of “unrealizable” to the status parameter of the query and assign a logical value of “no” to the logical parameter of the unrealizable query.

After the query based operation realization interface stores the user's query in the Historical Query Store at (434), it proceeds to (435) to notify the user that the operation realization interface was not able to realize the query, proceeds to (436) to provide help materials that are relevant to the user's query and finally returns to (400) for the user to enter a new query. See above for descriptions of (435), (436) and (400).

At (431), if the mapping the query to operations of the product is not successful, which means that the mapped operations can not be determined and which also means that the appropriate operations can not be determined, then the query based operation realization interface deals with the case that the mapping the query to operations of the product is not successful. In this preferred embodiment, the dealing with the case that the mapping the query to operations of the product is not successful is to perform ending handling of the query. That is to proceed to (434) to store the user's query as an unrealizable historical query in the Historical Query Store, proceed to (435) to notify the user that the operation realization interface was not able to realize the query, proceed to (436) to provide help materials that are relevant to the user's query and finally return to (400) for the user to enter a new query. See above for descriptions of (434), (435), (436) and (400).

At this point, either the query based operation realization interface has returned to (400) for the user to enter a new query, or the query based operation realization interface has successfully determined the user's desired operations and proceeded to (450).

At (450), the query based operation realization interface will check whether or not the appropriate operations contain dangerous operations.

What operations are deemed as “dangerous operations” depends on what the product is, and it also depends on what criteria the implementer of the query based operation realization interface set for “dangerous operations”.

For example, deleting data from hard disk that can never be recovered may be deemed a dangerous operation, uninstalling a program that can never be recovered may be deemed a dangerous operation, exiting the product with loss of unsaved data may be deemed a dangerous operation, and any operation that can't be reversed may be deemed a dangerous operation.

The query based operation realization interface provides a third data structure that stores all the operations that the product can perform. Similar to the means for forming the historical queries in Historical Query Store, a means for forming the operations to be stored in the third data structure is not to store any values of variables but use special symbols, such as “$”, to represent the variables, if the operation requires values of variables. Also, similar to the means for forming the standardized queries, the means for forming the operations can also include using the user's manual of the product as a reference to create the operations. The reason is the same: The user's manual typically covers all the operations of the product.

For each operation in the third data structure, the query based operation realization interface does the following: 1) provides a dangerous status parameter for the operation and assigns a dangerous status value of either “dangerous” or “not dangerous” to the dangerous status parameter of the operation, depending on whether or not the operation is deemed dangerous; 2) if the operation requires values of variables, associates with the operation a list of the variables, 3) provides a reversible status parameter for the operation and assigns a reversible status value of either “reversible” or “not reversible” to the reversible status parameter of the operation, depending on whether or not the operation is reversible; and 4) associates with the operations its reverse operations if operation is reversible. This third data structure is called an “Operation Data Store”.

At (450) for checking dangerous operations, the query based operation realization interface looks into the Operation Data Store to see whether or not the appropriate operations contain dangerous operations. If the appropriate operations don't contain any dangerous operations, then the query based operation realization interface proceeds to (460) to obtain values of variables contained in the appropriate operations for which the user doesn't provide values in her query.

At (450) for checking dangerous operations, If the appropriate operations contain dangerous operations, then the query based operation realization interface proceeds to (451) to prompt the user to confirm the dangerous operations. Here, the query based operation realization interface may provide explanations of why the dangerous operations are dangerous to get the user fully informed about the consequences of the operations.

When interacting with the user at (451), as mentioned in “B-3: The query based operation realization interface feedback device”, it's preferable to use graphics feedback devices, such as the screen of a PC monitor. However, if only sound based feedback devices are available or using a sound based feedback device is more appropriate, then the query based operation realization interface can use the sound based feedback devices to interact with the user at (451).

At (451) for confirming dangerous operations, if the user confirms that the operations are really what she wants, then the query based operation realization interface proceeds to (460)) to obtain values of variables contained in the appropriate operations for which the user doesn't provide values in her query.

At (451) for confirming dangerous operations, if the user denies the operations, then the query based operation realization interface returns to (400) for the user to enter a new query.

At this point, the query based operation realization interface either has returned to (400) for the user to enter a new query, or has reached (460) through some path.

At (460)) for obtaining values of variables contained in the appropriate operations for which the user doesn't provide values in her query, the query based operation realization interface checks into the Operation Data Store to determine whether or not the appropriate operations contain variables. If the appropriate operations contain variables but the user doesn't specify values for some of the variables in the query, then the query based operation realization interface prompts the user to provide values for the some of the variables.

Sometimes, the user's query would have already contained values of the variables for the appropriate operations. For example, in the Microsoft Excel example query “sum up row 3 to 100 and column 3 to 9” that was mentioned above, the values of all the variables are already specified. In this case, the query based operation realization interface doesn't need to obtain values of the variables from the user.

Sometimes, the user's query doesn't contain the values of variables that are needed for the appropriate operations. For example, when using Microsoft Word, if a user enters a query “create a table”, then this query doesn't contain information about the number of rows or the number of columns that the table should have. In this case, the query based operation realization interface prompts the user to provide values for the necessary variables, namely the number of rows and the number of columns.

Sometimes, the appropriate operations may contain some operations that depend on selections in multiple choices, but it may happen that the user doesn't specify her selections in her query, or the user forgets or doesn't know the dependency of the some operations on the selections in multiple choices. In this case, the query based operation realization interface provides the multiple choices and prompts the user to make selections.

In either requesting values of variables from the user or prompting the user to select in multiple choices, the query based operation realization interface can provide explanations for the variables or choices to help the user decide what values to provide for the variables or which choice to select from the multiple choices.

For providing explanations for the variables or choices, if an explanation is short, the query based operation realization interface can choose to provide the explanation unconditionally; if an explanation is long, the query based operation realization interface can choose to provide the explanation conditionally, such as that the explanations will be presented when the user clicks on a question mark that is a link to the explanations. Of course, to simplify the implementation, implementers of the query based operation realization interface can choose to provide all explanations unconditionally or to provide all explanations conditionally.

The query based operation realization interface can also establish default values of variables and default selection in multiple choices for users to verify or change if the users want to change. The query based operation realization interface can also simply realize the appropriate operations with the default values of variables or the default selection in multiple choices in case a user doesn't specify the values or the selections in her query. All these depend on actual implementations of the query based operation realization interface. However, it's generally preferable to request the values and prompt for the selections.

When interacting with the user at (460), as mentioned in “B-3: The query based operation realization interface feedback device”, it's preferable to use graphics feedback devices, such as screen of a PC monitor. However, if only sound based feedback devices are available or using a sound based feedback device is more appropriate, then the query based operation realization interface can use the sound based feedback devices to interact with the user at (460). When the feedback device is sound based, the explanations that the query based operation realization interface provides to the user may need to be brief and short, since the user may not be able to remember or digest long explanations.

At (460) for obtaining values of necessary variables for the appropriate operations, after obtaining all necessary inputs from the user, or if the operations don't need any inputs from the user, the query based operation realization interface proceeds to (470) to save operations history.

The query based operation realization interface keeps a stack of history of operations that the query based operation realization interface realized. The query based operation realization interface also associates a reversible operation with its reverse operations. This stack of history of operations is called Operation History Stack. The Operation History Stack is for the sake of undo already realized operations, if they are reversible.

Here, “stack” is a data structure which has a “last in first out” fashion. That is, the most recently stored item is the first to be retrieved. For the Operation History Stack, when activated for an undo, the most recently stored operations are first undone, if they are reversible.

After saving the operations in the Operation History Stack at (470), the query based operation realization interface proceeds to (480) to manipulate the product to realize the appropriate operations. At this point, all the operations and values of variables that are necessary for the operations have been determined. The query based operation realization interface has enough information to realize the appropriate operations of the product.

As mentioned in “B-1: Relationship between the query based operation realization interface and the product”, it's preferred to implement the query based operation realization interface as part of the product that the query based operation realization interface manipulates. Also as mentioned in “B-1: Relationship between the query based operation realization interface and the product”, in this preferred embodiment of the invention, the query based operation realization interface is implemented as part of the product.

Since the query based operation realization interface is part of the product, to realize the appropriate operations of the product, the query based operation realization interface manipulates the product by simply using the internal mechanisms of the product, whatever the mechanisms are. The internal mechanisms that the query based operation realization interface uses may be the same internal mechanisms that a menu based operation realization interface or a command based operation realization interface would use. This is convenient and easy, since no new mechanisms need to be introduced.

The convenience and ease for realizing operations of the product is the major reason for why it's preferred to implement the query based operation realization interface as part of the product. If the query based operation realization interface is implemented as a separate product, then, the query based operation realization interface has to realize operations of the product through some types of interaction mechanisms between the query based operation realization interface and the product. That adds implementation difficulties. Thus, even though it's possible to implement the query based operation realization interface as a separate product if there are interaction mechanisms between the query based operation realization interface and the product, generally it's not preferable to implement the query based operation realization interface as a separate product unless doing so is beneficial. The case that the query based operation realization interface is implemented as a separate product will be discussed in “F. Fourth Additional Embodiment”.

Sometimes, the appropriate operations will generate outputs, and the outputs need to be returned to the user. In this case, the query based operation realization interface can use the existing mechanisms that a menu based operation realization interface or a command based operation realization interface would use to return the outputs. In some cases, if appropriate, the query based operation realization interface can also use the feedback devices to provide the outputs to the user. Refer to “B-3: The query based operation realization interface feedback device” for detailed descriptions of feedback devices.

When realizing the appropriate operations at (480), the query based operation realization interface can notify the user that her goal is being realized. The query based operation realization interface does this notification by using the feedback devices. The reason for doing this notification is that some operations can take considerable amount of time to complete. If the query based operation realization interface doesn't let the user know in some way that her goal is being realized, the user may think that the query based operation realization interface doesn't work at all, since nothing happened and nothing is happening.

In notifying the user that her goal being realized, if it's possible to estimate the time required to complete the operations, it's preferable to let the user know the estimated time for completing the operations.

Also, in addition to the notification that the user's goal is being realized, the query based operation realization interface can also provide a cancelling feature (such as a button marked as “Cancel” in graphics feedback device case) so that the user can use to cancel realization of her goal if she chooses to do so.

After realizing the appropriate operations at (480), the query based operation realization interface returns to (400) for the user to enter a new query. This completes an entire cycle of handling one query.

In addition to the blocks described above for handling a query, the query based operation realization interface also provides two independent functionalities: “Cancel” functionality at (401) and “Undo” functionality at (402). The “Cancel” functionality (401) provides users with option to cancel the handling of her query at any time point before her goal is realized, such as when she is prompted to enter the value for a variable. The “Undo” functionality (402) provides users with option to reverse already realized operations if the already realized operations are reversible. A user can use the “Undo” functionality repeatedly to undo operations step by step back into the history of her operations, from the most recent ones to the least recent ones, provided the operations are reversible.

The functionalities “Cancel” (401) and “Undo” (402) can be implemented as two always-there functionalities along within the user query interface. For example, if the user query interface is implemented as a graphics based interface as shown in FIG. 2, then the “Cancel” (401) and “Undo” (402) can be implemented as two buttons around the input box, such as one at the left side and one at the right side of the box. A user can click on one of the two buttons to activate one of the two functionalities. See FIG. 2 for an example of the layout of the user query interface.

In fact, for all the things that are described above, typically, the “User query interface” (400), “Cancel” (401) and “Undo” (402) may be the only things accessible/viewable/etc. to users, such as the one shown in FIG. 2.

In the above descriptions, the data structures Historical Query Store, Standardized Query Store and Operation Data Store were introduced and described. In the three data structures, Standardized Query Store and Operation Data Store are tied to the product. If the product stays the same, those two data sets stay the same. Whenever the product is changed, such as adding new functionalities, removing existing functionalities, etc., then those two data sets need to be updated accordingly. For example, if the product adds new functionalities, new standardized queries with associated operations of the product need to be added to the Standardized Query Store, and new operations may also need to be added to the Operation Data Store if new operations are introduced. If the product removes existing functionalities, corresponding standardized queries need to be removed from the Standardized Query Store, and some existing operations may also need to be removed from the Operation Data Store if the operations don't exist anymore as a result of the change of the product. In summary, the Standardized Query Store and Operation Data Store may need to be updated with updating of the product.

The Historical Query Store is tied to both the product and the users of the query based operation realization interface. First, whenever the product is changed, the Historical Query Store needs to be updated to reflect changes of the product. For example, whenever existing functionalities are removed from the product, if there are historical queries whose realizations entirely or partly depend on those functionalities of the product, Historical Query Store need to be updated to associate those historical queries with a status of “unrealizable”.

Second, whenever users enter a new query for which there are no matched historical queries, the Historical Query Store is updated automatically by the query based operation realization interface according to the process of adding a new user query to the Historical Query Store described above. Thus, the Historical Query Store may still change even though the product stays the same.

Another kind of update of the data structure Historical Query Store is a periodic update of the data structure. Details of this type of update of Historical Query Store will be described in “B-5: How to perform periodic update of the Historical Query Store” below.

### B-5: How to Perform periodic Update of the Historical Query Store (FIG. 9 and FIG. 10)

As described above, the query based operation realization interface has an automatic mapping mechanism to map the query to operations of the product. However, regardless of how sophisticated the automatic mapping mechanism is, it's possible that it can't recognize or determine what exactly the goal of a user query is or whether the goal is realizable or not, even though the query might be valid and realizable. If that happens, then, the query based operation realization interface will place the query in the Historical Query Store, assign a value of “unrealizable” to the status parameter of the query and assign a logical value of “no” to the logical parameter of the query. (See “B-4: Detailed flow of instructions of the query based operation realization interface” for details.)

To compensate for the possible mistakes that the automatic mapping mechanism might make, the query based operation realization interface periodically collects unrealizable historical queries, send the unrealizable historical queries to the vender of the query based operation realization interface (or, any responsible parties other than the vender) for the vender to perform manual analysis of the historical queries. The query based operation realization interface will update the Historical Query Store based on the results of vender's manual analysis of the unrealizable historical queries. This type of update of the Historical Query Store is called periodic update of the Historical Query Store. The query based operation realization interface performs the periodic updates when it's not handling any user queries. (The term “vender” is used to represent the party responsible for the manual analysis of the unrealizable historical queries. The “vender” may be the implementer, seller, or any responsible parties of the query based operation realization interface.)

A periodic update of the Historical Query Store comprises: checking whether or not there are updated historical queries from the vender of the query based operation realization interface, if there are updated historical queries then obtaining the updated historical queries and updating the historical queries in the Historical Query Store, collecting unrealizable historical queries in the Historical Query Store that haven't been manually analyzed, and sending the not yet manually analyzed unrealizable historical queries to the vender for the vender to perform manual analysis on the not yet manually analyzed unrealizable historical queries. (The actions may be implemented in a different order.)

The “collecting unrealizable historical queries that haven't been manually analyzed” is collecting the unrealizable historical queries in the Historical Query Store that have logical value “no” for their logical parameter. The logical parameter is particularly designed for the purpose of performing the periodic update. The logical value “no” initially assigned to the logical parameter of an unrealizable historical query by the query based operation realization interface means that the query has not been manually analyzed.

The query based operation realization interface may perform the “obtaining the updated historical queries” and “sending the historical queries not yet manually analyzed” by using the Internet.

Another way of doing the periodic update of the Historical Query Store is performing the periodic update each time a user uses the query based operation realization interface. However, it's preferred to do the periodic update periodically, such as once a week, once two weeks, once a month, or in other time intervals. This is dependent on how the periodic update is implemented in the query based operation realization interface.

After the vender of the query based operation realization interface receives a certain number of unrealizable historical queries, the vender will perform manual analysis of each of those queries to determine what the goal of the query is and whether or not the query is really unrealizable. The historical queries will be updated based on the results of the manual analysis. Those manually analyzed and updated historical queries are then made available for the query based operation realization interface to obtain and update in its Historical Query Store (the “obtaining” and “updating” steps in the periodic update). Below are details of how the manual analysis is performed and how the updating of the Historical Query Store is performed.

### B-5-1) Manual Analysis of Unrealizable Historical Queries (FIG. 9)

After the vender of the query based operation realization interface receives a certain number of unrealizable historical queries, the vender will perform manual analysis of each of those queries to determine what the goal of the historical query is and whether or not the historical query is really unrealizable. The historical queries will be updated based on the results of the manual analysis. Here, the “certain number” is a number deemed appropriate by the vender. The number may be dependent on the resources that the vender has available for performing the tasks, and it may be dependent on other factors. Also, the number could be different at different times.

FIG. 9 shows the flowchart of the manual analysis of the unrealizable historical queries. In all the blocks in FIG. 9, actually only the block (920) involves human activities. All other blocks may be implemented solely as automatic processes using some type of programming languages, and it's assumed that's the case here. The block (920) is the manual analysis of a historical query. The reason that the term “manual analysis” is used to represent the entire process is to emphasize that this is different from the automatic mapping that is done by the query based operation realization interface. For the sake of descriptions, the term “Analyzer” is used to represent the program that performs the automatic processes. However, again, the block (920) involves human actions.

At (900), a list is created to contain all the historical queries to be manually analyzed. The list contains at least one historical query; otherwise, nothing needs to be done. This list is called To-be-analyzed Query List.

After the To-be-analyzed Query List is created, the Analyzer proceeds to (910) to pick the first historical query from the To-be-analyzed Query List and proceeds to (920) to perform manual analysis of the historical query to determine whether or not the historical queries is really unrealizable.

If the historical query is determined to be really unrealizable, then the Analyzer proceeds to (921) to keep the status value “unrealizable” for the status parameter of the historical query and change the logical value from “no” to “yes” for the logical parameter of the historical query, meaning that the historical query has been manually analyzed. Then, the Analyzer proceeds to (930).

If the historical query is determined to be actually realizable, then the Analyzer proceeds to (922) to change the status value from “unrealizable” to “realizable” for the status parameter of the historical query and associate the historical query with a series of operations of the product that can be performed to realize the historical query. Then, the Analyzer proceeds to (930).

At this point, the Analyzer has proceeded to (930) from some path. At (930), the Analyzer moves the historical query from To-be-analyzed Query List to a list that holds all the historical queries that have been manually analyzed. This second list is called To-be-loaded Query List.

After moving the historical query from To-be-analyzed Query List to To-be-loaded Query List at (930), the Analyzer proceeds to (940) to check whether To-be-analyzed Query List is empty or not.

If To-be-analyzed Query List is not empty, which means that there are still historical queries in the To-be-analyzed Query List that need manual analysis, then the Analyzer proceeds back to (910) to process another historical query.

At (940), if To-be-analyzed Query List is empty, which means that all the historical queries initially in To-be-analyzed Query List have been manually analyzed and which means that To-be-loaded Query List should contain all the historical queries initially in To-be-analyzed Query List, then, the Analyzer proceeds to (950) to end the entire process of manual analysis. At this point, those manually analyzed and updated historical queries are made available for the query based operation realization interface to obtain and update in its Historical Query Store.

The vender of the query based operation realization interface may receive different historical queries from multiple query based operation realization interfaces that are used by different users. However, after manual analysis and update the historical queries, the vender can make the updated historical queries available to all the query based operation realization interfaces used by different users, regardless of the fact that a particular historical query may be received from a particular query based operation realization interface. In this way, all the users (or in other words, all the query based operation realization interfaces) can get all the updates.

Also, the vender of the query based operation realization interface can analyze why the automatic mapping mechanism of the query based operation realization interface doesn't work on some user queries, and then, the vender can make changes to improve and enhance the automatic mapping mechanism so that the automatic mapping mechanism can perform better when mapping a user query to operations of the product.

### B-5-2) Update of Historical Query Store (FIG. 10)

When performing the periodic update of the Historical Query Store, after the query based operation realization interface checks and finds out that there are updates available from the vender of the query based operation realization interface, then the query based operation realization interface will obtain all the updated historical queries and update them in its Historical Query Store.

FIG. 10 shows the flowchart of the update of Historical Query Store. All the blocks in FIG. 10 are automatic processes implemented through some type programming languages. For the sake of easier descriptions, the term “Updater” is used to represent the program that performs the update of the Historical Query Store.

At (1000) the Updater creates a list to contain all the historical queries from the vender that need to be updated. This list is called To-be-updated Query List. After creating To-be-updated Query List, the Updater proceeds to (1010).

At (1010), the Updater picks the first historical query from To-be-updated Query List and proceeds to (1020) to check whether or not the historical query is already in the Historical Query Store.

If the historical query is already in the Historical Query Store, then the Updater proceeds to (1021) to update the historical query and then proceeds to (1030). Here, “update” means replace the old attributes (status value, logical value, etc.) of the historical query in the Historical Query Store by the new attributes (status value, logical value, series of operations if applicable, etc.) of the updated historical query in the To-be-updated Query List.

If the historical query is not yet in the Historical Query Store, then the Updater proceeds to (1022) to add the historical query to the Historical Query Store with all its attributes (status values, logical value, series of operations if applicable, etc.) in the To-be-updated Query List, and then proceeds to (1030).

At this point, the Updater has proceeded to (1030) from some path. At (1030), the Updater removes the historical query from To-be-updated Query List, and then proceeds to (1040) to check whether To-be-updated Query List is empty or not.

If To-be-updated Query List is not empty, which means that there are still historical queries in the To-be-updated Query List that need to be updated in the Historical Query Store, then the Updater proceeds back to (1010) to process another historical query.

At (1040), if To-be-updated Query List is empty, which means that all the historical queries initially in To-be-updated Query List have been updated in the Historical Query Store, then the Updater proceeds to (1050) to end the entire process of updating the Historical Query Store.

The Historical Query Store may be mature with time, and the periodic update of the Historical Query Store may be needed less and less frequently. Thus, with the mature of the Historical Query Store, the time interval for the periodic update may be set larger and larger.

### B-6: How to Use Query Based Operation Realization Interface (FIG. 2)

It has been mentioned that, in the preferred embodiment, the query based operation realization interface is implemented as part of the product it manipulates, and the user input device is a hand based device.

Also, for the sake of descriptions and explanations, it's assumed that the user interface of the query based operation realization interface, which is the user query interface, is in the following situation: The user query interface has an input box that a user can enter a query. FIG. 2 shows one form of the layout of such a case. The entire appearance of the user query interface is simple, clear and self explained.

When there is a query based operation realization interface for a product, then whenever a user uses the product, the user query interface (as shown in FIG. 2) is available for the user to use. Since the query based operation realization interface is part of the product, the user query interface can be embedded in the overall interface of the product. For example, for an application program on Windows PC, such as Microsoft Word, the overall interface is a window on the screen of the monitor. The user query interface will be in the Microsoft Word window, either at the top, at the bottom or at somewhere else.

To use the query based operation realization interface, all that the user needs to do is: Enter her desired goal of the product as a query through the user query interface and let the query based operation realization interface realize her goal.

Using the one shown in FIG. 2 as an example, what a user needs to do is: Type a query in the input box and then click on the button “Realize”.

The query based operation realization interface can be implemented in such a way that, after a user enters a query in the input box, the user can either click on the “Realize” button or press “enter” key on the keyboard (assuming a keyboard is the user input device) to let the query based operation realization interface start handling the query.

The user's query describes what goal of the product that the user wants to realize. After the user enters her query, the query based operation realization interface takes the responsibilities to process the query to determine appropriate operations of the product that, when realized, realize the user's goal and manipulate the product to realize the appropriate operations so to realize the user's goal.

For example, for a query based operation realization interface for Microsoft Excel, a user can enter a query like “sum up row 3 to 100 and column 3 to 9” and click on the “Realize” button. Then, the query based operation realization interface will cause Excel to add all the numbers in the range row 3 to 100 and column 3 to 9, and show the result to the user.

Of course, for a query based operation realization interface with the “Cancel” and “Undo” buttons as those shown in FIG. 2, a user can also click on one of the two buttons to use one of the two functionalities.

In the course of realizing a user's query, sometimes, the user may need to specify values for some variables. In that case, the query based operation realization interface will prompt the user to enter values. Sometimes, the user may need to make selection in multiple choices. In that case, the query based operation realization interface will present the choices to the user for her to select. In all the cases, the query based operation realization interface may provide explanations of the variables, choices, etc. to help the user provide values or make selections.

For example, for a query based operation realization interface for Microsoft Windows, a user may enter a query like “make my PC run as fast as possible” when the user notices that her PC runs significantly slower with time. Then, to make the PC run faster, the query based operation realization interface will manipulate Microsoft Windows to perform various tasks such as remove auto-start programs, clear out forgotten programs, free up wasted disk space, de-fragment the PC, detect and repair disk errors, etc. For some of the tasks, such as de-fragment the PC, the query based operation realization interface doesn't need the user's inputs. The query based operation realization interface can simply go ahead cause Microsoft Windows to complete the task. However, for some of the tasks, such as remove auto-start programs, the query based operation realization interface may need the user's inputs. The query based operation realization interface may present all unnecessary auto-start programs and prompt the user to choose which ones to remove. Of course, the query based operation realization interface may explain what those programs do and why removing the programs helps the PC's performance.

From the above descriptions of how to use the query based operation realization interface, we can clearly see again the following advantages of the query based operation realization interface:

For realizing a particular goal using the query based operation realization interface, a user doesn't need to know all the menus or commands that are otherwise necessary for a menu based operation realization interface or a command based operation realization interface. The user only needs to enter her goal as a query through the user query interface using her own words. This also saves the user's time, since using a menu based operation realization interface or a command based operation realization interface sometimes takes a lot of steps.

A user doesn't need to remember any specific way of expressing a goal. She can enter one query at one time, and at a later time, she can enter a different query for the same goal.

For a same goal, different users are free to enter different queries using their own words. This provides great convenience and flexibility to users.

Complicated functionalities of the product are as easy as simple functionalities to any users. For example, in the Microsoft Windows example that was just mentioned in which a user wants to improve the performance of her PC, the user needs to do a lot of things if she uses the menu or command based operation realization interfaces currently available on Microsoft Windows. However, if the user uses a query based operation realization interface, then the user only needs to enter a query like “make my PC run as fast as possible”.

For products that use the query based operation realization interface, when a user of one product switches to use another product with same or similar functionalities, the user doesn't need to take time to learn how to use the new product, since the queries that the user needs to enter are the same for same operations, whether on the old product or on the new product.

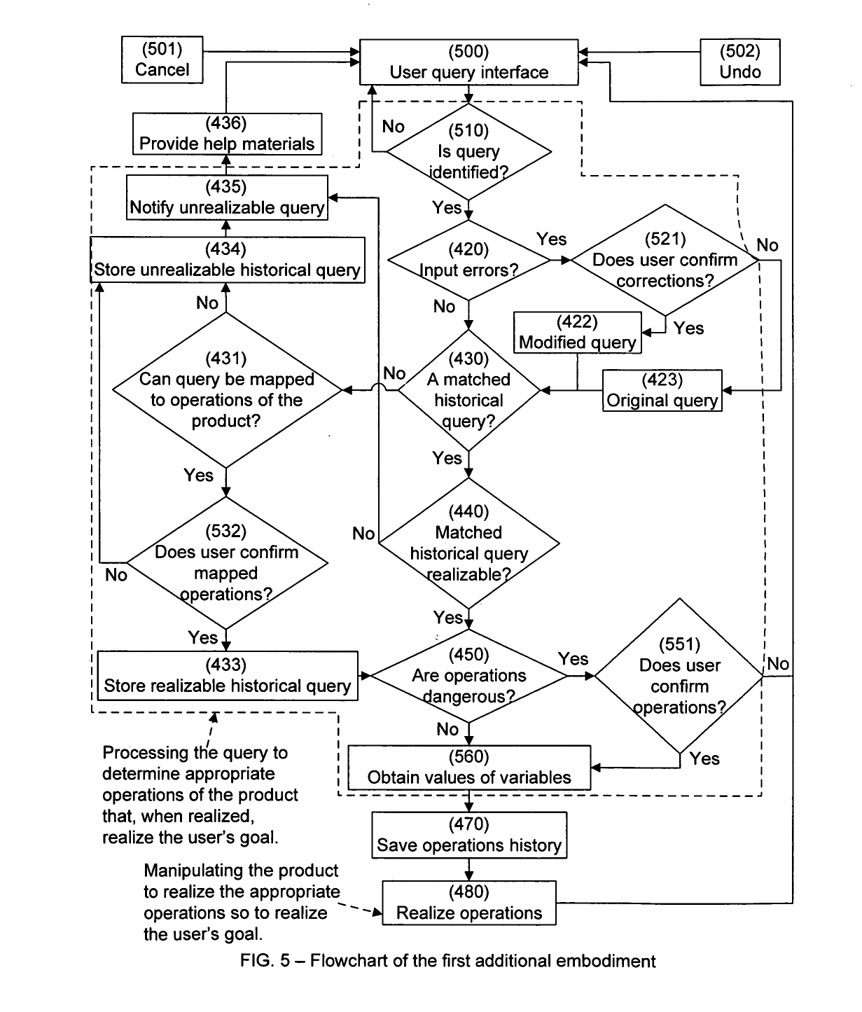

### C. First Additional Embodiment (FIG. 3, FIG. 5, FIG. 9 and FIG. 10)

The major difference of this additional embodiment from the preferred embodiment is that the user input device in this additional embodiment is a sound based input device. Because of this difference, the major difference between the detailed flow of instructions of this additional embodiment and that of the preferred embodiment is the way that users enter their queries and additional inputs when prompted by the query based operation realization interface. The internal mechanisms of the query based operation realization interface in this additional embodiment are the same as those in the preferred embodiment. This is shown in FIG. 5.

Details of this additional embodiment will be described with six parts: C-1: Relationship between the query based operation realization interface and the product; C-2: User input device; C-3: The query based operation realization interface feedback device; C4: Detailed flow of instructions of the query based operation realization interface; C-5: How to perform periodic update of the Historical Query Store; and C-6: How to use the query based operation realization interface.

### C-1: Relationship Between the Query Based Operation Realization Interface and the Product (FIG. 3)

The relationship between the query based operation realization interface and the product is the same as that in the preferred embodiment, as shown in FIG. 3. Refer to “B-1: Relationship between the query based operation realization interface and the product” for detailed descriptions.

### C-2: User Input Device

In the preferred embodiment, the user input device is a hand based device. In this additional embodiment, the user input device is a sound based device, such as a microphone.

For a sound based user input device, such as a microphone, additional confirmations may be needed to identify a user query. The reason is that sound input may be realized through oral languages. Due to the nature of human oral languages, such as different pronunciations and different accents for a same word, sound inputs usually are less accurate and more difficult to identify. Thus, for a sound based input device, extra work may need to be done to identify the user's inputs. For example, normally, an automatic telephone answering system often reads back and confirms that it identifies a user's spoken words (sound inputs) correctly.

Even though the query based operation realization interface may need to do extra work to identify users' queries for sound based user input devices, using a sound based input device may be more appropriate under some circumstances.

For an example, using sound based input devices may be more appropriate than using hand based input devices on a cell phone, such as a regular cell phone or an Apple's iPhone. The reason is that, on simple cell phones, one key button represents multiple alphabetic letters which makes it time consuming to type in a query. On more advanced cell phones, a single letter corresponds to a single key button, but the key buttons are too small which makes it time consuming to type in a query, too. On an Apple iPhone, the displayed alphabetic letters on the screen are too small which also makes it time consuming to type in a query. Thus, using sound based input devices on a cell phone may be more appropriate for the query based operation realization interface.

For another example, using a sound based input device may be appropriate for a person who is driving a car. The reason is that, when a person is driving a car, her hands are typically occupied. However, she can still talk to a sound based input device to enter her query for the query based operation realization interface.

In cases that a sound based input device is appropriate but the product doesn't have associated appropriate sound based input devices, then appropriate sound based input devices may need to be added to the product for the query based operation realization interface to use.

In this additional embodiment, it's assumed that the user input device is a sound based input device. This is the major difference between this additional embodiment and the preferred embodiment.

### C-3: The query based operation realization interface feedback device

The feedback device that the query based operation realization interface uses to interact with users is the same as that in the preferred embodiment. Refer to “B-3: The query based operation realization interface feedback device” for detailed descriptions.

### C-4: Detailed Flow of Instructions of the Query Based Operation Realization Interface (FIG. 5)

As already mentioned, the major difference of this additional embodiment from the preferred embodiment is that the user input device in this additional embodiment is a sound based input device. Because of this difference, the major difference between the detailed flow of instructions of this additional embodiment and the detailed flow of instructions of the preferred embodiment is the way that users enter their queries and additional inputs when prompted by the query based operation realization interface. The internal mechanisms of the query based operation realization interface in this additional embodiment are the same as those in the preferred embodiment. This is shown in FIG. 5.

In FIG. 5, the blocks that are the same as those in the preferred embodiment have the same block numbers as those in FIG. 4. For example, the block number of “Save operations history” is (470) in both FIG. 4 and FIG. 5. The blocks in FIG. 5 that are different from their counterparts in FIG. 4 have a different first digit “5”. For example, the block number of “User query interface” is (400) in FIG. 4, but is (500) in FIG. 5.

Only the blocks that are different in this additional embodiment will be described. For descriptions of the blocks that are the same as those in the preferred embodiment (as shown in FIG. 4), refer to “B-4: Detailed flow of instructions of the query based operation realization interface” for detailed descriptions.

The user query interface (500) is different from that in the preferred embodiment. Since the user input device is a sound based device, the user query interface may also be sound based interface. For example, if the user input device is a microphone, then the user query interface is the microphone itself. A user can orally enter her queries through the microphone.

After receiving a sound input query at (500), the query based operation realization interface proceeds to (510) to try to identify what the user's sound input is. This is different from that in the preferred embodiment. In the preferred embodiment, the query based operation realization interface mat not need to take much efforts to identify the user's inputs, unless the hand based input device is some type of inaccurate devices, such as a handwriting board. For sound based inputs, the query based operation realization interface may need to take efforts to identify and confirm the user's inputs.

The block to ask the user to confirm corrections to the original query at (521), the block to ask the user to confirm mapped standardized queries at (532), the block to ask the user to confirm dangerous operations at (551) and the block to obtain necessary variables at (560) are different from those in the preferred embodiment. The difference is that, in this additional embodiment, the user uses the sound based input device to enter her confirmation/denial and choices/values. Repeated confirmations may be needed if the query based operation realization interface has difficulty to identify the user's sound inputs.

Finally, the “Cancel” (501) and “Undo” (502) blocks are different. The query based operation realization interface can notify a user of availability of the “Cancel” functionality before the query based operation realization interface starts to handle a user's query, and the query based operation realization interface can notify the user availability of the “Undo” functionality again after it successfully realizes the user's goal.

When notifying a user availability of the “Cancel” and “Undo” functionalities, the query based operation realization interface can use either graphics based feedback device, sound based feedback device, or both, whichever available and appropriate. The user uses the sound based input device to activate one of the two functionalities. Again, repeated confirmations may be needed if the query based operation realization interface has difficulty to identify the user's sound inputs.

### C-5: How to Perform Periodic Update of the Historical Query Store (FIG. 9 and FIG. 10)

How to perform periodic update of the Historical Query Store is the same as that in the preferred embodiment, as shown in FIG. 9 and FIG. 10. Refer to “B-5: How to perform periodic update of the Historical Query Store” for detailed descriptions.

### C-6: How to Use the Query Based Operation Realization Interface

The use of the query based operation realization interface is the same as that in the preferred embodiment except that 1) the user enters her query orally through a sound based device, 2) the user enters confirmation/denial and choices/values requested by the query based operation realization interface through the sound based device, and 3) the user activates one of the “Cancel” and “Undo” functionalities through the sound based device.

For example, for a query based operation realization interface for a cell phone, a user can orally enter (that is, speak) a query like “change the current date to Jan. 6, 2008”. Then, the query based operation realization interface will cause the cell phone to set the current date to Jan. 6, 2008.

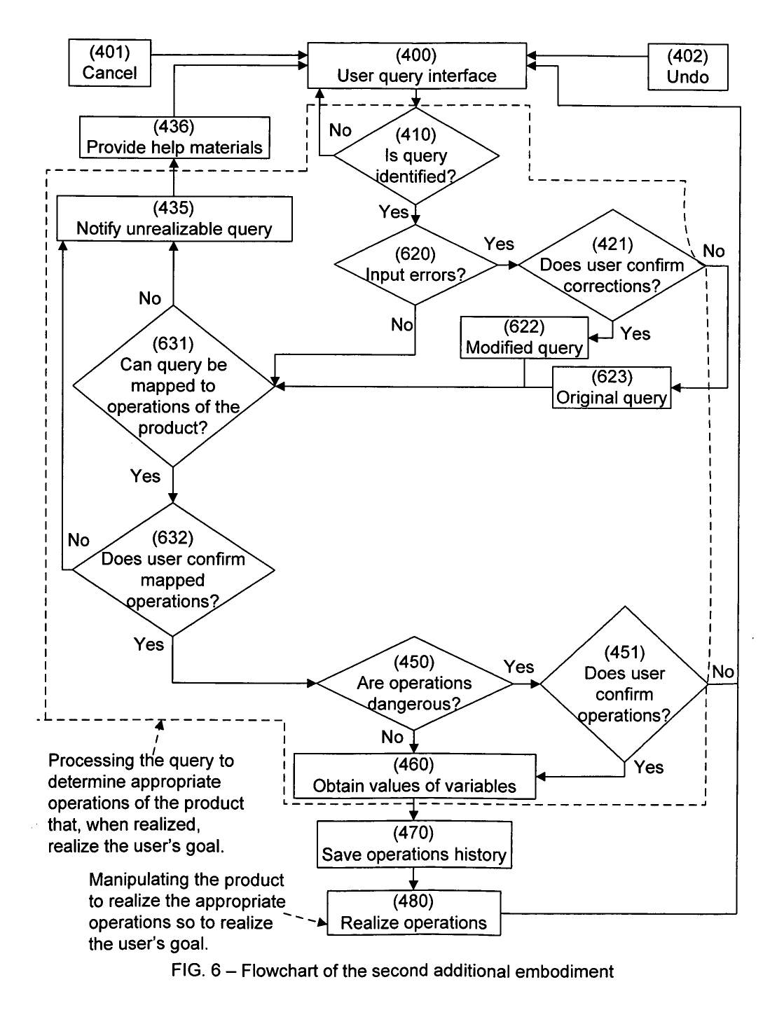

### D. Second Additional Embodiment (FIG. 6)

The difference between this additional embodiment and the preferred embodiment is in the detailed flow of instructions shown in the flowchart in FIG. 6: When processing the query to determine appropriate operations of the product that, when realized, realize the user's goal, this embodiment only does the mapping the query to operations of the product to determine the appropriate operations. It doesn't do the utilizing historical queries. The consequences of this difference are: 1) This embodiment doesn't have the blocks (430), (433), (434) or (440) in FIG. 4 in the preferred embodiment; 2) The blocks (620), (622), (623), (631) and (632) are different from their counterparts in FIG. 4 in the preferred embodiment. That's why these blocks have a first digit “6” in their block numbers in FIG. 6. All other blocks are the same as those in FIG. 4 in the preferred embodiment; 3) Due to not doing the utilizing historical queries, this embodiment doesn't need the Historical Query Store, and thus the “How to perform periodic update of the Historical Query Store” in the preferred embodiment doesn't apply to this additional embodiment.

Below, only the blocks that are different from their counterparts in FIG. 4 are described. Refer to “B. Preferred Embodiment” for details of all the other blocks. Also, refer to “B. Preferred Embodiment” for details of other respects, namely the “Relationship between the query based operation realization interface and the product”, “User input device”, “The query based operation realization interface feedback device” and “How to use the query based operation realization interface”.

The difference between the blocks (620), (622) and (623) and their counterparts in FIG. 4 is: instead of proceeding to (430) in FIG. 4 to perform utilizing historical queries to determine the appropriate operations, the blocks (620), (622) and (623) proceeds to (631) to do the mapping the query to operations of the product to determine appropriate operations of the product that, when realized, realize the user's goal. Refer to “B. Preferred Embodiment” for further details.

The difference between the block (631) and its counterpart in FIG. 4 is: if the mapping the query to operations of the product is not successful at (631), which means that the mapped operations can not be determined and which also means that the appropriate operations can not be determined, the dealing with the case that the mapping the query to operations of the product is not successful is different in that the ending handling of the query is different. The difference is that, in this additional embodiment, instead of storing the query as an unrealizable historical query in the Historical Query Store before notifying the user of an unrealizable query, ending handling of the query procedure immediately proceeds to (435) to notify the user of the unrealizable query. Refer to “B. Preferred Embodiment” for further details.

The difference between the block (632) and its counterpart in FIG. 4 are: 1) if the user confirms the mapped operations, which means that the appropriate operations are determined, then the dealing with the case that the user confirms the mapped operations is that, instead of storing the query as a realizable historical query in the Historical Query Store before proceeding to (450) to perform dangerous operations checking, block (632) immediately proceeds to (450) to perform dangerous operations checking; and 2) if the user denies the mapped operations, which means that the appropriate operations can not be determined, then the dealing with the case that the user denies the mapped operations is that, instead of storing the query as an unrealizable historical query in the Historical Query Store before proceeding to (435) to notify the user of the unrealizable query, block (632) performs ending handling of the query by immediately proceeding to (435) to notify the user of the unrealizable query. Refer to “B. Preferred Embodiment” for further details.

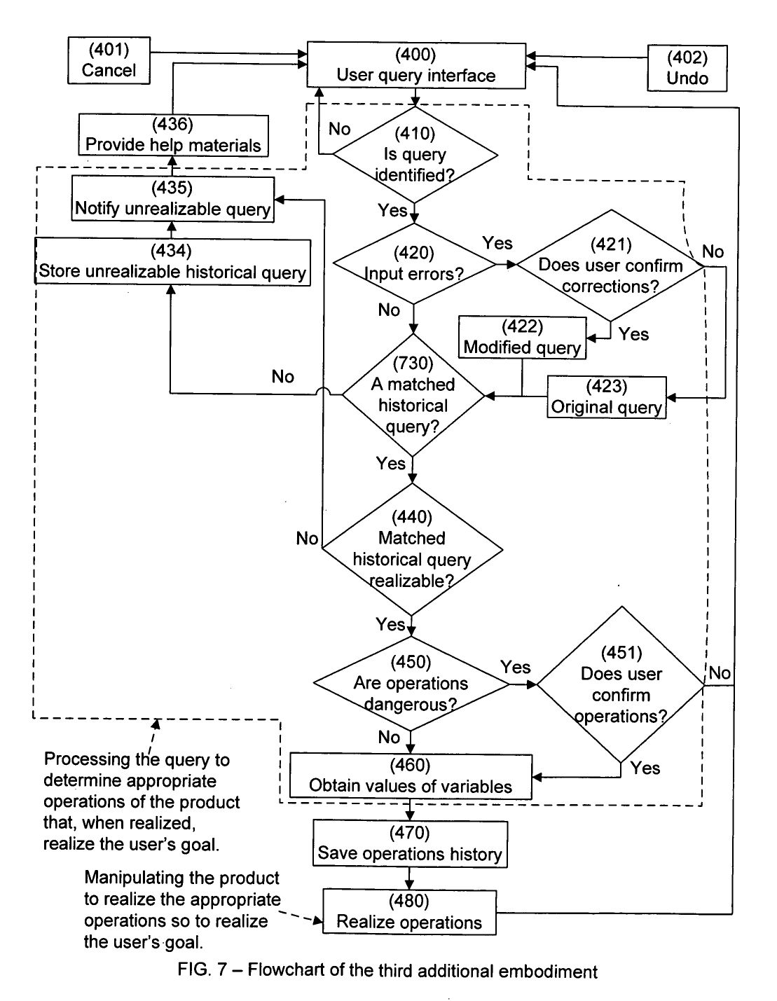

### E. Third Additional Embodiment (FIG. 7)

The difference between this additional embodiment and the preferred embodiment is in the detailed flow of instructions shown in the flowchart in FIG. 7: When processing the query to determine appropriate operations of the product that, when realized, realize the user's goal, this embodiment only does utilizing historical queries to determine the appropriate operations at (730). It doesn't do the mapping the query to operations of the product to determine the appropriate operations even it's not successful at (730) (meaning there are no matched historical queries.) The consequences of this difference are: 1) This embodiment doesn't have the blocks (431), (432) or (433) in FIG. 4 in the preferred embodiment; 2) The block (730) for utilizing historical queries to determine the appropriate operations is different from its counterpart in the preferred embodiment, which is (430) in FIG. 4. That's why the block number has a first digit “7” in FIG. 7. All other blocks are the same as those in FIG. 4 in the preferred embodiment; 3) Due to not doing the mapping the query to operations of the product, this embodiment doesn't need the Standardized Query Store.

As mentioned above, the difference from the preferred embodiment is only in the detailed flow of instructions. Thus, below, only the block (730) and corresponding differences will be described. Refer to “B. Preferred Embodiment” for details of all the other blocks. Also, refer to “B. Preferred Embodiment” for details of other respects, namely the “Relationship between the query based operation realization interface and the product”, “User input device”, “The query based operation realization interface feedback device”, “How to perform periodic update of the Historical Query Store” and “How to use the query based operation realization interface”.

At (730) in FIG. 7, the difference from the counterpart in FIG. 4 is: The dealing with the case that there are no matched historical queries is different. In this additional embodiment, when there are no matched historical queries, the block (730) immediately proceeds to (434) to store the query as an unrealizable historical query. Refer to “B. Preferred Embodiment” for further details.

Due to the immediate exit in the case that there are no matched historical queries, the Historical Query Store in this additional embodiment should be formulated differently to better handle a user query. In the preferred embodiment, the Historical Query Store basically contains actual queries (with the variation that values of variables are represented by special symbols) that users enter. In this additional embodiment, the initial Historical Query Store needs to contain “artificial” historical queries—queries that are not entered by users.

Basically, the artificial historical queries are included in the Historical Query Store when the query based operation realization interface is implemented. One good reference for formulating those artificial historical queries is the user's manual of the product. (As mentioned before, sometimes, the user's manual is in the form of online help materials along with the product. That is especially the case when the product is a software product.) It's similar to the forming of standardized queries based on the user's manual described in “B. Preferred Embodiment”. Of course, the artificial historical queries can be more comprehensive so that it can perform better at (730) when trying to find a matched historical query.

Another thing worthy of pointing out is that the periodic update of the Historical Query Store may need to be performed more often, especially in the early life period of the query based operation realization interface. This will help the performance of the query based operation realization interface at block (730), meaning that it can do a better job at (730).

Finally, this additional embodiment has an advantage over the preferred embodiment, the first and second additional embodiments described above and the fourth and fifth additional embodiments to be described below: this additional embodiment is easier to implement. The preferred embodiment all the other additional embodiments all implement a mapping mechanism to map a user's query to operations of the product. However, this additional embodiment doesn't have the mapping mechanism. This additional embodiment only implements the utilizing historical queries to determine the appropriate operations at (730), which basically only requires a Historical Query Store. It's normally relatively easier to form an initial Historical Query Store than to implement the mapping mechanism. In this additional embodiment, if the initial Historical Query Store is formed comprehensively and appropriately, it may significantly compensate for the disadvantage of not having a mapping mechanism to map a user's query to operations of the product.

### F. Fourth Additional Embodiment

In the preferred embodiment, there are two ways to determine appropriate operations of the product that, when realized, realize the user's goal: one way is utilizing historical queries at (430) in FIG. 4, and the other way is mapping the query to operations of the product at (431) in FIG. 4. The order of the two ways in the preferred embodiment is performing the utilizing historical queries first, and then performing the mapping the query to operations of the product second if utilizing historical queries to determine the appropriate operations is not successful.

Actually, the order of the two ways can be changed. That is, performing the mapping the query to operations of the product first, and then performing the utilizing historical queries second if the mapping the query to operations of the product is not successful. This additional embodiment implements this order. This change of order results some changes in the detailed flow of instructions, and the changes are described below.

The change to blocks (420), (422) and (423) in FIG. 4 is: instead of proceeding to (430) to perform the utilizing historical queries to determine the appropriate operations first, the blocks proceed to (431) to perform the mapping the query to operations of the product first.

The change to block (431) in FIG. 4 is: the dealing with the case that the mapping the query to operations of the product is not successful is changed. When the mapping the query to operations of the product is not successful, which means that the mapped operations can not be determined, instead of ending handling of the query, the block proceeds to (430) to perform the utilizing historical queries to determine the appropriate operations.

The change to block (430) in FIG. 4 is: when there are no matched historical queries, instead of proceeding to (431) to perform the mapping the query to operations of the product, the block proceeds to (434) to store the query as an unrealizable historical query in the Historical Query Store.

All other blocks stay the same as those in the preferred embodiment. Refer to “B. Preferred Embodiment” for further details. Also, refer to “B. Preferred Embodiment” for details of other respects, namely “Relationship between the query based operation realization interface and the product”, “User input device”, “The query based operation realization interface feedback device”, “How to perform periodic update of the Historical Query Store” and “How to use the query based operation realization interface”.

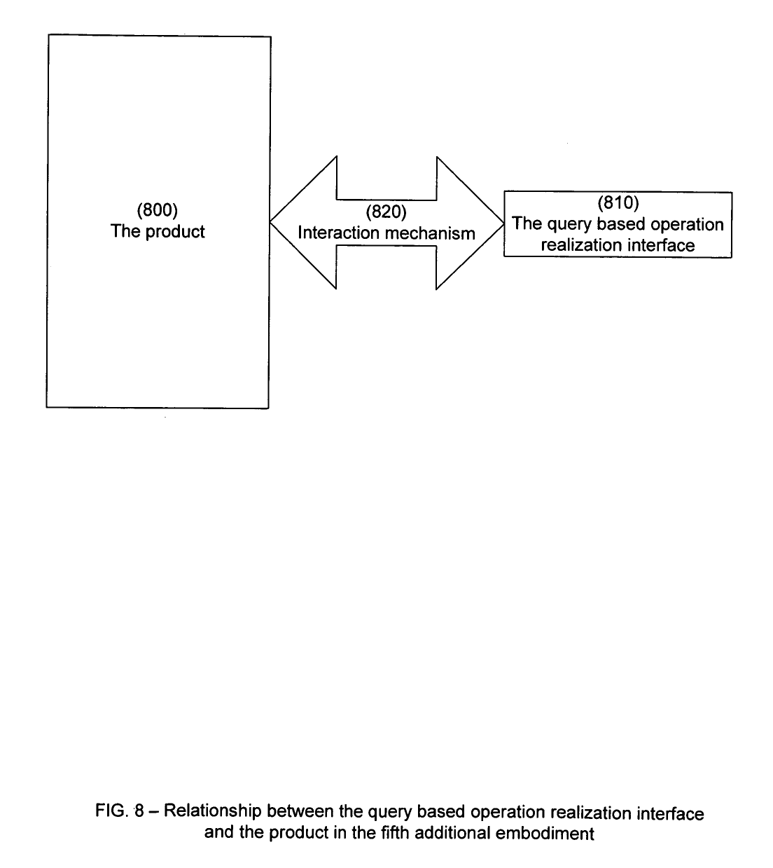

### G. Fifth Additional Embodiment (FIG. 8)

In the preferred embodiment, the query based operation realization interface is implemented as part of the product that the query based operation realization interface manipulates, as shown in FIG. 3.

FIG. 8 shows an alternative form of the relationship of the query based operation realization interface (810) and the product (800) that the query based operation realization interface manipulates. In this alternative form, the query based operation realization interface (810) is implemented independently as a separate product. The query based operation realization interface (810) manipulates the product (800) through an interaction mechanism (820) between the query based operation realization interface and the product.

The interaction mechanism (820) can be of any forms as appropriate. For example, in the HDTV example mentioned earlier, the HDTV and the remote control board (i.e., the operation realization interface) can be viewed as two separate products. The remote control board manipulates the HDTV through electric signals with different signals prescribed as representing different operations that the HDTV should realize. For another example, when the product (800) is a piece of computer software, it may have application programming interfaces (APIs) that the query based operation realization interface (810) can utilize to manipulate the software (800). In this example, the use of the APIs is the interaction mechanism. (Here, “application programming interfaces” are well defined interfaces that a software package (i.e., a set of programs) provides for other programs to use to interact with the software package.)

The difference between the detailed flow of instructions of this embodiment and the preferred embodiment resides in the last block, which is the block (480) in FIG. 4. In the preferred embodiment, the block (480) uses the internal mechanisms of the product to realize the determined appropriate operations of the product. In this embodiment, the block needs to use the interaction mechanism to realize the determined appropriate operations of the product. This adds difficulty to the implementation of the query based operation realization interface.

Refer to “B. Preferred Embodiment” for further details of the detailed flow of instructions. Also Refer to “B. Preferred Embodiment” for details of other respects, namely “User input device”, “The query based operation realization interface feedback device”, “How to perform periodic update of the Historical Query Store” and “How to use the query based operation realization interface”.

Since the query based operation realization interface is implemented as a separate product, the separate product needs to have its own digital storage medium to store the instructions of the query based operation realization interface. The separate product may also need its own user input devices and/or feedback devices.

### H. More Variations

It should be understood that the above descriptions of the preferred and additional embodiments should not be construed as limiting the scope of the present invention. The descriptions should be appreciated by those skilled in the art that the conception and the specific embodiments disclosed may be readily utilized as a basis for modifying or designing other structures (including but not limited to various changes, substitutions and alterations) for carrying out the same or similar purposes of the present invention, and that such equivalent constructions do not depart from the spirit and scope of the invention.

Below are some examples of possible modifications/variations. Again, the following examples should not be construed as limiting the scope of the present invention.

(1) All the fifth additional embodiments are based on variations from the preferred embodiment. Actually, the variations can be combined to create new embodiments. For an example, in the second, third, fourth and fifth additional embodiments, the user input device can be a sound based input device. For another example, in the first, second, third and fourth additional embodiments, the query based operation realization interface can be implemented as a separate product.

The various variations below are also based on the preferred embodiment. However, it should be understood that those variations may be applied to the additional embodiments when applicable.

(2) FIG. 2 shows one form of the layout for a graphics based user query interface. Actually, the user query interface can take a form that is similar to the typical appearance of a command based operation realization interface, such as that of the Command Prompt on Microsoft Windows.

(3) In the preferred embodiments, the Historical Query Store basically contains queries that are actually entered by users. An alternative way is to also store “artificial” historical queries (queries not entered by users) in the Historical Query Store. The artificial historical queries may be included in the initial Historical Query Store when the query based operation realization interface is implemented. As mentioned in the third additional embodiment, one good reference for formulating those artificial historical queries is the user's manual of the product.

(4) In the preferred embodiment and all the additional embodiments except the third embodiment, the mapping the query to operations of the product is done by creating and utilizing the second data structure called Standardized Query Store. A standardized query in the Standardized Query Store is associated with a series of operations of the product. The Standardized Query Store functions like an intermediate medium through which an actual user query is mapped to operations of the product.

Different methods, whether simpler or more complicated, can be applied to map the user's query to operations of the product.

(5) In the preferred embodiments (FIG. 4), the utilizing of historical queries at (430) is to check whether or not there is a matched historical query. A “matched” query is stronger than a “mapped” query at (431) in that, except for values of variables and variables themselves, all other texts need to be the same for “matched”. The criterion for a “matched” query can be different. It can be the same as the criterion for a “mapped” query. This may increase the chance of success at (430).

(6) In the preferred embodiment (FIG. 4), there are two data structures Historical Query Store and Standardized Query Store. Implementers of the query based operation realization interface can choose to combine these two data structures into one and use the combined data structure for the purpose of performing the utilizing historical queries at (430) and for the purpose of performing the mapping the query to operations of the product at (431). This may increase the chance of success at (430) and (431).

(7) In the preferred embodiment (FIG. 4), there are two data structures Standardized Query Store and Operation Data Store. Implementers of the query based operation realization interface can choose to combine these two data structures into one that represents all operations of the product in the form of standardized queries. This combined data structure can be used to do the mapping the query to operations of the product at (431), can be used to do the dangerous operations checking at (450), and also can be used for checking and obtaining values of necessary variables for the determined appropriate operations at (460).

(8) In the preferred and additional embodiments that were described above, the user input devices are either hand based or sound based. Actually, the user input devices can also be both hand and sound based, such as the devices on a cell phone. On a cell phone, the key pad or virtual key pad (like what an Apple iPhone has) is a hand based device, and the microphone is a sound based device. The query based operation realization interface manipulating a cell phone can be implemented to utilize both the key pad and the microphone for users to enter queries.

(9) The query based operation realization interface feedback devices can also be both hand based and sound based. The query based operation realization interface can be implemented to utilize both the hand based and sound based devices to give feedbacks to users and interact with users.

(10) In the preferred embodiment (FIG. 4), there is a block of identifying user's query at (410). It's mentioned that the query based operation realization interface may ask the user for her to confirm an identified query in some cases when user input device is an inaccurate device, such an electronic handwriting board. Implementers of the query based operation realization interface can choose not to do the user confirmation. The implementers can choose to implement the query based operation realization interface in such a way that it simply returns to the user query interface (400) from (410) when it has suspicions about the identified query that is entered from an inaccurate device.

(11) In the preferred embodiment (FIG. 4), there are the detecting and correcting possible input errors at (420), (421) and (422). Implementers of the query based operation realization interface can choose not to do the input errors detecting or correcting. Then, after the query based operation realization interface successfully identifies a user query at (410), the query based operation realization interface proceeds directly to (430) to utilize historical queries to determine the appropriate operations.

(12) In the preferred embodiment (FIG. 4), there is a safeguard mechanism of asking the user to confirm mapped operations at (432). Implementers of the query based operation realization interface can choose not to do the user confirmation. Then, the query based operation realization interface simply doesn't have the block (432) in the flow of instructions shown in FIG. 4.

Choosing not to have the safeguard mechanism (432) for the mapped operations could be risky, especially in the early time of the life of a query based operation realization interface. The reason is that the mapping mechanism may not be good enough yet at early time, and the mapping mechanism may mis-map user's queries. If the mis-mapping happens, then the query based operation realization interface will realize something that is not desired by the user. Thus, it's preferred to have the safeguard mechanism (432).

(13) In the preferred embodiment (FIG. 4), there is a block of notifying the user of unrealizable query at (435). Implementers of the query based operation realization interface can choose not to have this block. Then, the query based operation realization interface simply proceeds to (436) from where it currently proceeds to (435).

(14) In the preferred embodiment (FIG. 4), there is a block of providing help materials to the user at (436). Implementers of the query based operation realization interface can choose not to have this block. Then, the query based operation realization interface simply returns to the user query interface (400) from where it currently proceeds to (436).

(15) In the preferred embodiment (FIG. 4), there is a block of dangerous operations checking at (450) and (451). Implementers of the query based operation realization interface can choose not to do the dangerous operations checking. Then, after the appropriate operations of the product are determined, the query based operation realization interface proceeds directly to (460) from either (433) or (440) to obtain values of necessary variables for the operations.

(16) In the preferred embodiment (FIG. 4), there is “Cancel” functionality at (401), and there is “Undo” functionality at (402). Implementers of the query based operation realization interface can choose not to have either of or both of these two functionalities.

(17) In the preferred embodiment (FIG. 4), there is a block of saving operations history at (470). This is necessary if implementers of the query based operation realization interface implement the “Undo” functionality at (402) or the implementers implement the query based operation realization interface in a way that the query based operation realization interface undoes last already realized operations when a user requests to undo by entering a query like “undo last operations” through the user query interface.

The implementers can choose not to implement the undo functionality at all. In this case, the block (470) is not needed.

(18) For a particular product and for a variable for a particular operation of the product, due to intrinsic limitations, there may be a limit on values that the variable can take. If that particular operation is performed with a variable value exceeding the limit, then, the product (especially a software product) may return error messages.

Even though the product itself may return error messages if values of some variables are not valid values, implementers of the query based operation realization interface can choose to add a block to the preferred embodiment (FIG. 4) to check whether or not values of variables exceed limitations. If the block detects invalid values for some variables, then the query based operation realization interface can feedback the errors to the user and prompt the user to change the invalid values.

### I. Conclusions, Ramifications and Scope of the Present Invention

(1) Below is a summary of the disadvantages of menu and command based operation realization interfaces, and the corresponding advantages of the query based operation realization interface of the present invention.

(Disadvantage—1) Menu and Command Based Operation Realization Interfaces

For realizing a particular goal using menu or command based operation realization interfaces, a user needs to have knowledge about the processes (menus, sub-menus, sub-sub-menus, and so on; commands and arguments of commands; orders of steps; etc.) for realizing the goal. If the user doesn't have the necessary knowledge, then, she needs to spend time to acquire the knowledge.

(Advantage—1) The Query Based Operation Realization Interface

For realizing a particular goal using the query based operation realization interface, a user only needs to enter her goal as a query through the user query interface using her own words. The user doesn't need to know the menus, commands, etc. that are otherwise necessary for using menu or command based operation realization interfaces.

(Disadvantage—2) Menu and Command Based Operation Realization Interfaces

For realizing a particular goal using menu or command based operation realization interfaces, even for a user who has learned how to realize the goal at one time, later on, when she needs to realize the same goal again, she may already forget the particular and exact process (menus, commands, etc.) Then, she needs to take time to repeat the learning process of acquiring the necessary knowledge for realizing the goal.

(Advantage—2) The Query Based Operation Realization Interface

For realizing a particular goal using the query based operation realization interface, a user doesn't need to remember any specific ways of expressing a goal. She can enter one query at one time, and at a later time, she can enter a different query for the same goal.

(Disadvantage—3) Menu and Command Based Operation Realization Interfaces

For realizing a particular goal using menu or command based operation realization interfaces, even a user has adequate knowledge to realize her goal, the user still needs to perform the process step by step (menu by menu, or, command by command) to actually realize the goal. Sometimes, there may be a lot of steps to go through, and it may take the user considerable time and efforts to go through all the steps.

(Advantage—3) The Query Based Operation Realization Interface

For realizing a particular goal using the query based operation realization interface, a user only needs to enter her goal as a query through the user query interface. This saves the user's time.

(Disadvantage—4) Menu and Command Based Operation Realization Interfaces

Menu and command based operation realization interfaces lack flexibility in that, for realizing a particular goal, users have to go through exactly the same process (same menus, or, same commands.)

(Advantage—4) The Query Based Operation Realization Interface

When using the query based operation realization interface, for a same goal, different users are free to enter different queries using their own words.

(Disadvantage—5) Menu and Command Based Operation Realization Interfaces

A product, especially a complex software product, may have a lot of functionalities. Some of the functionalities may be very complicated. When the product uses menu or command based operation realization interfaces, it's very hard and time consuming for an ordinary user to learn all the menus or commands for using all the functionalities, most of the functionalities, or even a significant fraction of the functionalities. Thus, a lot of functionalities of a product, especially a complex software product, are unknown and thus meaningless to ordinary users, since ordinary users don't have the necessary knowledge of the particular and exact processes (menus, commands, orders of steps, etc.) for using the functionalities.

(Advantage—5) The Query Based Operation Realization Interface

When a product uses the query based operation realization interface, complicated functionalities of the product are as easy as simple functionalities to any users. Whether a piece of functionality is complicated or not, what a user needs to do is the same: Enter her goal as a query through the user query interface.

(Disadvantage—6) Menu and Command Based Operation Realization Interfaces

For products that use menu based or/and command based operation realization interfaces, especially for software products, when a user of one product switches to use another product, even though the two products have same or similar functionalities, the user still may need to take considerable time to learn the specific menus or commands of the new product, since the old product and the new product may have different menus or commands for same operations.

(Advantage—6) The Query Based Operation Realization Interface

For products that use the query based operation realization interface, when a user of one product switches to use another product with same or similar functionalities, the user doesn't need to take time to learn how to use the new product, since the queries that the user needs to enter are the same for same operations, whether on the old product or on the new product.

The above is a summary of the disadvantages of menu and command based operation realization interfaces, and the corresponding advantages of the query based operation realization interface of the present invention

(2) In software product cases, the query based operation realization interface is typically most useful for manipulating software products that have a lot of functionalities, such as Microsoft Windows, Apple Macintosh, Microsoft Office products, etc. Adding the query based operation realization interface to a piece of complex software will be valuable.

In hardware product cases, the query based operation realization interface is typically most useful for manipulating a piece of complex hardware, such as an airplane, a modern sophisticated cell phone, a sophisticated equipment, etc. Adding the query based operation realization interface to a piece of complex hardware will be valuable.

For a piece of very simple hardware, such as a regular chair, a simple regular telephone, etc., adding the query based operation realization interface may not be as valuable as adding the query based operation realization interface to a piece of complex software product or hardware product.

(3) For the sake of easy understanding, the product examples used mostly are products that already have menu based or/and command based operation realization interfaces, since those are the most common cases. However, actually, applicable areas of the query based operation realization interface of the present invention are broader than that. The query based operation realization interface can be implemented to manipulate a product that doesn't already have any menu or command based operation realization interfaces.

(4) It should be understood that all the software product and hardware product examples mentioned in this disclosure are for the sake of descriptions and explanations. They should not limit the scope of the present invention. Those skilled in the art may apply the present invention to or implement the present invention with any products that can be manipulated by the query based operation realization interface of the present invention.

(5) It should be understood that, even though in the cases that the query based operation realization interface is implemented in addition to the existing menu based and/or command based operation realization interfaces that the product already has, with improvement and maturity of the query based operation realization interface, venders of the product may choose to hide or drop the existing menu based and/or command based operation realization interfaces, and make the query based operation realization interface as the major and default operation realization interface of the product.

(6) It should be understood that the above descriptions (including but not limited to all the embodiments and their variations, and examples) are meant to be illustrative of the principles and various embodiments of the present invention. The above descriptions should not be construed as limiting the scope of the present invention. Numerous variations and modifications (including but not limited to various changes, adding similar parts or steps, taking off parts or steps, modifying parts or steps, substitutions and alterations) will become apparent to those skilled in the art once the above disclosure is fully appreciated, and such constructions do not depart from the spirit and scope of the present invention.

The scope of the invention should be determined by the appended claims and their legal equivalents and extensions, and riot by the embodiments, variations or examples given.

1. A method for an operation realization interface, comprising:
(1.a) providing a user query interface so that a user can use to enter a query to describe her goal of a product;
(1.b) processing the query to determine appropriate operations of the product that, when realized, realize the user's goal; and
(1.c) manipulating the product to realize the appropriate operations so to realize the user's goal.

2. The method of claim 1, wherein said providing a user query interface comprises providing a graphics based interface.

3. The method of claim 2, wherein said providing a graphics based interface comprises providing a layout of the graphics based interface.

4. The method of claim 1, wherein said providing a user query interface comprises providing a sound based interface.

5. The method of claim 1, wherein said providing a user query interface comprises providing a graphics and sound based interface.

6. The method of claim 1, wherein said processing the query to determine appropriate operations comprises utilizing historical queries to determine the appropriate operations.

7. The method of claim 6, wherein said utilizing historical queries comprises:
(7.a) providing a first data structure for storing the historical queries, with a parameter indicating whether a historical query is realizable or unrealizable, and with a series of operations associated with a realizable historical query, the series of operations being the operations that, when performed, realize the realizable historical query;
(7.b) checking whether or not there is a matched historical query in the first data structure;
(7.c) if there is a matched historical query in the first data structure, then checking whether or not the matched historical query is realizable; and
(7.d) if the matched historical query is realizable, then identifying the appropriate operations as the series of operations associated with the realizable historical query in the first data structure.

8. The method of claim 7, wherein said providing a first data structure comprises providing a means for forming the historical queries.

9. The method of claim 7, further comprising performing periodic update of the first data structure.

10. The method of claim 7, further comprising storing the query as an unrealizable historical query in the first data structure if there are no matched historical queries.

11. The method of claim 1, wherein said processing the query to determine appropriate operations comprises mapping the query to operations of the product to determine the appropriate operations, with the operations of the product termed as mapped operations.

12. The method of claim 11, wherein said mapping the query to operations of the product comprises:
(12.a) providing a second data structure for storing standardized queries; and
(12.b) mapping the query to one or more standardized queries in the second data structure to determine the mapped operations.

13. The method of claim 12, wherein said providing a second data structure comprises providing a means for forming the standardized queries.

14. The method of claim 12, wherein said mapping the query to one or more standardized queries in the second data structure comprises performing key word analysis to map the query to one or more standardized queries in the second data structure.

15. The method of claim 11, wherein said mapping the query to operations of the product comprises, if the mapped operations are determined, then:
(15.a) providing a safeguard mechanism to ask the user to confirm that the mapped operations are the user's desired operations; and
(15.b) if the user confirms the mapped operations, then identifying the appropriate operations as the mapped operations.

16. (canceled)

17. (canceled)

18. (canceled)

19. (canceled)

20. The method of claim 1, wherein said processing the query to determine appropriate operations comprises notifying the user of unrealizable query if the appropriate operations can not be determined.

21. The method of claim 1, wherein said processing the query to determine appropriate operations comprises ending handling of the query if the appropriate operations can not be determined.

22. The method of claim 1, wherein said processing the query to determine appropriate operations comprises obtaining values of variables contained in the appropriate operations for which the user doesn't provide values in the query.

23. The method of claim 1, wherein said processing the query to determine appropriate operations comprises checking whether or not the appropriate operations contain dangerous operations.

24. The method of claim 1, wherein said processing the query to determine appropriate operations comprises, if the appropriate operations contain some operations that depend on selections in multiple choices but the user doesn't specify in the query her selections, then providing the multiple choices and prompting the user to make selections.

25. The method of claim 1, further comprising providing the user with help materials if the appropriate operations can not be determined.

26. The method of claim 25, wherein said providing the user with help materials comprises:
(26.a) taking the query as a search query;
(26.b) searching the help materials database of the product with the search query; and
(26.c) providing the user with matched documents generated by said searching.

27. The method of claim 1, further comprising providing a digital storage medium for storing instructions of the operation realization interface.

28. The method of claim 1, further comprising implementing the operation realization interface as part of the product.

29. The method of claim 1, further comprising implementing the operation realization interface as a separate product.

30. An operation realization interface, comprising:
(30.a) a user query interface that a user can use to enter a query to describe her goal of a product;
(30.b) first means for processing the query to determine appropriate operations of the product that, when realized, realize the user's goal; and
(30.c) second means for manipulating the product to realize the appropriate operations so to realize the user's goal.

31. The operation realization interface of claim 30, wherein said user query interface comprises a graphics based interface.

32. The operation realization interface of claim 31, further comprising a layout of the graphics based interface.

33. The operation realization interface of claim 30, wherein said user query interface comprises a sound based interface.

34. The operation realization interface of claim 30, wherein said user query interface comprises a graphics and sound based interface.

35. The operation realization interface of claim 30, wherein said first means comprises third means for utilizing historical queries to determine the appropriate operations.

36. The operation realization interface of claim 35, wherein said third means comprises:
(36.a) a first data structure for storing the historical queries, with a parameter indicating whether a historical query is realizable or unrealizable, and with a series of operations associated with a realizable historical query, the series of operations being the operations that, when performed, realize the realizable historical query;
(36.b) fourth means for checking whether or not there is a matched historical query in said first data structure; and
(36.c) fifth means for checking whether or not a matched historical query is realizable to determine the appropriate operations.

37. The operation realization interface of claim 36, further comprising sixth means for performing periodic update of said first data structure.

38. The operation realization interface of claim 30 wherein said first means comprises seventh means for mapping the query to operations of the product to determine the appropriate operations, with the operations of the product termed as mapped operations.

39. The operation realization interface of claim 38, wherein said seventh means comprises:
(39.a) a second data structure for storing standardized queries; and
(39.b) eighth means for mapping the query to one or more standardized queries in the second data structure to determine the mapped operations.

40. The operation realization interface of claim 39, wherein said eighth means comprises ninth means for performing key word analysis to map the query to one or more standardized queries in said second data structure.

41. The operation realization interface of claim 38, wherein said seventh means comprises safeguard means for asking the user to confirm that the mapped operations are the user's desired operations.

42. The operation realization interface of claim 30, wherein said first means comprises tenth means for ending handling of the query if the appropriate operations can not be determined.

43. The operation realization interface of claim 30, wherein said first means comprises eleventh means for obtaining values of variables contained in the appropriate operations for which the user doesn't provide values in the query.

44. The operation realization interface of claim 30, wherein said first means comprises twelfth means for asking the user to confirm dangerous operations.

45. The operation realization interface of claim 30, wherein said first means comprises thirteenth means for providing multiple choices and prompting the user to make selections in the multiple choices, if the appropriate operations contain some operations that depend on selections in the multiple choices but the user doesn't specify her selections in the query.

46. The operation realization interface of claim 30, further comprising fourteenth means for providing the user with help materials if the appropriate operations can not be determined.

47. The operation realization interface of claim 30, further comprising a digital storage medium for storing instructions of said operation realization interface.

48. The method of claim 1, wherein said processing the query to determine appropriate operations comprises:
(48.a) utilizing historical queries to determine the appropriate operations; and
(48.b) mapping the query to operations of the product to determine the appropriate operations, with the operations of the product termed as mapped operations.

49. The method of claim 48, wherein said utilizing historical queries comprises:
(49.a) providing a first data structure for storing the historical queries, with a parameter indicating whether a historical query is realizable or unrealizable and with a series of operations associated with a realizable historical query, the series of operations being the operations that, when performed, realize the realizable historical query;
(49.b) checking whether or not there is a matched historical query in the first data structure;
(49.c) if there is a matched historical query in the first data structure, then checking whether or not the matched historical query is realizable; and
(49.d) if the matched historical query is realizable, then identifying the appropriate operations as the series of operations associated with the realizable historical query in the first data structure.

50. The method of claim 49, wherein said providing a first data structure comprises providing a means for forming the historical queries.

51. The method of claim 49, further comprising performing periodic update of the first data structure.

52. The method of claim 49, further comprising storing the query as an unrealizable historical query in the first data structure if there are no matched historical queries.

53. The method of claim 48, wherein said mapping the query to operations of the product comprises:
(53.a) providing a second data structure for storing standardized queries; and
(53.b) mapping the query to one or more standardized queries in the second data structure to determine the mapped operations.

54. The method of claim 53, wherein said providing a second data structure comprises providing a means for forming the standardized queries.

55. The method of claim 53, wherein said mapping the query to one or more standardized queries in the second data structure comprises performing key word analysis to map the query to one or more standardized queries in the second data structure.

56. The method of claim 48, wherein said mapping the query to operations of the product comprises, if the mapped operations are determined, then:
(56.a) providing a safeguard mechanism to ask the user to confirm that the mapped operations are the user's desired operations; and
(56.b) if the user confirms the mapped operations, then identifying the appropriate operations as the mapped operations.

57. The method of claim 49, wherein said mapping the query to operations of the product comprises, if the appropriate operations are determined, then storing the query as a realizable historical query in the first data structure and associating the appropriate operations with the realizable historical query in the first data structure.

58. The method of claim 49, wherein said mapping the query to operations of the product comprises, if the appropriate operations can not be determined, then storing the query as an unrealizable historical query in the first data structure.

59. A method for processing a query to determine appropriate operations of a product that, when realized, realize the goal of the query, comprising utilizing historical queries to determine the appropriate operations.

60. The method of claim 59, wherein said utilizing historical queries comprises:
(60.a) providing a first data structure for storing the historical queries, with a parameter indicating whether a historical query is realizable or unrealizable, and with a series of operations associated with a realizable historical query, the series of operations being the operations that, when performed, realize the realizable historical query;
(60.b) checking whether or not there is a matched historical query in the first data structure;
(60.c) if there is a matched historical query in the first data structure, then checking whether or not the matched historical query is realizable; and
(60.d) if the matched historical query is realizable, then identifying the appropriate operations as the series of operations associated with the realizable historical query in the first data structure.

61. The method of claim 60, wherein said providing a first data structure comprises providing a means for forming the historical queries.

62. The method of claim 60, further comprising performing periodic update of the first data structure.

63. The method of claim 60, further comprising storing the query as an unrealizable historical query in the first data structure if there are no matched historical queries.

64. A method for processing a query to determine appropriate operations of a product that, when realized, realize the goal of the query, comprising mapping the query to operations of the product to determine the appropriate operations, with the operations of the product termed as mapped operations.

65. The method of claim 64, wherein said mapping the query to operations of the product comprises:
(65.a) providing a second data structure for storing standardized queries; and
(65.b) mapping the query to one or more standardized queries in the second data structure to determine the mapped operations.

66. The method of claim 65, wherein said providing a second data structure comprises providing a means for forming the standardized queries.

67. The method of claim 65, wherein said mapping the query to one or more standardized queries in the second data structure comprises performing key word analysis to map the query to one or more standardized queries in the second data structure.
